(19) United States
(12) Patent Application Publication
(10) Pub. No.: US 2026/0135666 A1
(43) Pub. Date: May 14, 2026

(54) CORESET ZERO FOR NR OPERATION WITH NARROW CHANNEL BANDWIDTH

(71) Applicant: Telefonaktiebolaget LM Ericsson (publ), Stockholm (SE)

(72) Inventors: Kittipong Kittichokechai, Järfälla (SE); Gerardo Agni Medina Acosta, Märsta (SE); Keerthi Kumar Nagalapur, Göteborg (SE); Mirza Uzair Baig, Märsta (SE)

(21) Appl. No.: 19/119,263

(22) PCT Filed: Oct. 31, 2023
(86) PCT No.: PCT/IB2023/060955

§ 371 Date: Apr. 8, 2025

Related U.S. Application Data
(60) Provisional application No. 63/420,920, filed on Oct. 31, 2022.

(51) Int. Cl. H04L 5/00; H04W 72/0453; H04W 72/23

(52) U.S. Cl. CPC H04L 5/0053; H04L 5/0094; H04W 72/0453; H04W 72/23

(57) ABSTRACT

Systems and methods are disclosed that are related to puncturing of Control Resource Set (CORESET) #0, e.g., for operation in a narrow channel bandwidth. In one embodiment, a method performed by a User Equipment (UE) comprises operating in a wireless spectrum allocation that is smaller than an amount of frequency domain resources needed for receiving a Synchronization Signal (SS)/Physical Broadcast Channel (PBCH) block (SSB) and CORESET #0. The method further comprises receiving, from a network node, an SSB and CORESET #0 after puncturing, wherein puncturing of the SSB is determined by a number of resource blocks (RBs) comprised in the wireless spectrum allocation within a respective frequency band and puncturing of a Physical Downlink Control Channel (PDCCH) mapped to the CORESET #0 is determined by the puncturing of the SSB and one or more offset parameters. The method further comprises decoding a message based on the PBCH/PDCCH.

### RELATED APPLICATIONS

This application claims the benefit of provisional patent application Ser. No. 63/420,920, filed Oct. 31, 2022, the disclosure of which is hereby incorporated herein by reference in its entirety.

### TECHNICAL FIELD

The present disclosure relates to a wireless communication system and, more specifically, operation in a wireless communication system when using only a narrow channel bandwidth.

### BACKGROUND

At the 3^{rd} Generation Partnership Project (3GPP) meeting RAN #94-e, a new Work Item (WI) on “NR support for dedicated spectrum less than 5 MHz for FR1” was approved (see RP-213603, “NR support for dedicated spectrum less than 5 MHz for FR1,” 3GPP TSG RAN meeting #94e, Electronic Meeting, Dec. 6-17, 2021). The Work Item Description (WID) relates to the use cases of Future Railway Mobile Communication System (FRMCS), utilities, and public safety for which the following has been highlighted as part of the WID's justification, as shown in the following excerpt from RP-213603.
Rail Communication in Europe is used for operational purposes to ensure the safety of millions of rail passengers. The Future Railway Mobile Communication System (FRMCS) forms the basis for digitizing rail operations with the aim of increasing train path utilization and improving punctuality. For the use of the harmonized 900 MHz spectrum block (2×5.6 MHz FDD), for a period of approximately 10 years from 2025 onwards, constraints stem from the need to operate in parallel FRMCS and the currently deployed and operational GSM-R system. Depending on the traffic volume and location, GSM-R requires a significant portion of the 4 MHz according to the GSM-R band definition (according to 3GPP TS 45.005), although this is expected to reduce as traffic migrates from GSM-R to FRMCS. Consequently, possibilities in 5G NR to operate in bandwidths <5 MHz (e.g., from around 3 MHz upwards) would enable parallel operation of FRMCS and GSM-R and massive infrastructure reuse.
Around 1 million rail vehicles are registered in Europe. The vehicles, mostly closed train compositions with two driving heads, which are already equipped with GSM-R today, usually have 2 GSM-R UEs up to 6 UEs when European Train Control System is used. This group of vehicles makes up around 10%. It is expected that a second group of rail vehicles (approx. 40%) will be equipped with FRMCS capabilities during the course of the next decade. Upgrading the remaining vehicles with FRMCS is done in a broader schedule. The responsible authorities and organizations in Europe have set the start of the migration from GSM-R to FRMCS for 2025.
The provision of simultaneous use of the 2×5.6 MHz FDD in the 900 MHz frequency band and the associated provision of bandwidths less than 5 MHz for 5G NR thus has a key function in order to be able to start the migration from GSM-R to FRMCS in Europe.
In summary, FRMCS plays a key role in the automation of rail operations. It is anticipated that this will lead to a significant improvement in route utilization and thus also contribute to the reduction of greenhouse gases.
For Public Protection and Disaster Relief (PPDR), 2×3 MHz FDD in band 28 has been identified in Europe.
NR specifications starting in Rel-15 defined a minimum bandwidth of 5 MHz channels. Although NR can support multiple channel bandwidths due to the flexible numerology implementation, channel bandwidths smaller than this are currently not supported in NR. The minimum PRB size in multiples of 4 and the size of the PBCH are the determining factors in not being able to scale to smaller than 5 MHz channel bandwidths.

In line with the WID's justification, the following 3GPP Rel-18 objectives for RAN1 have been defined as described in RP-213603:

The following objectives shall be included for dedicated FDD spectrum in FR1:
Identify and specify necessary changes to NR physical layer with minimum specification impact to operate in spectrum allocations from approximately 3 MHz up to below 5 MHz [RAN1]:
   Restrict to subcarrier spacing of 15 kHz and the use of normal cyclic prefix.
   For SSB:
      Reuse PSS/SSS specification without puncturing.
      PBCH based on current design.
   Identify and specify necessary minimum changes to PDCCH, CSI-RS/TRS, PUCCH, and PRACH for functional support based on existing design, without optimization

The present disclosure focuses on the part of the objective touching upon Control Resource Set #0 (CORESET #0) in which Physical Downlink Control Channel (PDCCH) is transmitted for the associated dedicated spectrum.

### I New Radio (NR) Synchronization Signal Block (SSB)

The most fundamental aspects of SSB can be summarized as follows (see 3GPP Technical Specification (TS) 38.211 v17.3.0 and 3GPP TS 38.213 v17.3.0):
An SSB contains the Primary Synchronization Signal (PSS), Secondary Synchronization signal (SSS), and Physical Broadcast channel (PBCH) along with the Demodulation Reference Signal (DMRS).
   PBCH carries the Master Information Block (MIB)
In frequency domain, one SSB block occupies 20 contiguous resource blocks which is equivalent to 240 subcarriers, as illustrated in FIG. 1 which shows the time-frequency structure of an SSB. In time domain, one SSB block spans over four Orthogonal Frequency Division Multiplexing (OFDM) symbols. Among the four ODFM symbols, one symbol is for PSS, one symbol is for SSS, and two symbols are for PBCH. Specifically, PSS occupies the first OFDM symbol of SSB and spans over 127 subcarriers. SSS is located in the third OFDM symbol of SSB and spans over 127 subcarriers. The total number of resource elements (REs) used for PBCH transmission per SSB is 576. There are, however, 113 unused subcarriers in the first symbol, and 17 unused subcarriers in the third symbol, as shown in FIG. 1. Therefore, there are 130 unused REs within an SSB. In the current NR design, the complex-valued symbols corresponding to these unused REs are set to zero. One or more SSBs can be transmitted per synchronization signal (SS) burst in accordance with Table 1 below.
“Cell search” for SSB (also referred to as “SS/PBCH block”) accounting for different carrier frequencies and subcarrier spacings:
   Within one half-frame there are several occurrences of SSBs;
   The SSBs can be located in the first or second half of the frame as indicated via MIB;
   One or multiple SSBs (i.e., a group of occurrences) compose an SS burst;
   The SS burst periodicity can be 5 milliseconds (ms), 10 ms, 20 ms, 40 ms, 80 ms, or 160 ms.

TABLE 1
Max number of SSBs per SS burst depending
on SCS and carrier frequency

| | | Maximum number of SSBs per SS burst | | |
|---|---|---|---|---|
| | SCS (kHz) | f_{c} < 3 GHz | 3 GHz ≤ f_{c} ≤ 6 GHz | 6 GHz < f_{c} |
| Case A | 15 | 4 | 8 | |
| Case B | 30 | 4 | 8 | |
| Case C | 30 | 4 | 8 | |
| Case D | 120 | | | 64 |
| Case E | 240 | | | 64 |

Note that SSB is positioned on one of the synchronization raster as defined in 3GPP TS 38.104 v17.7.0 for a given operating band. The synchronization raster maps to subcarrier number 120 of the SSB, i.e., approximately the mid-point of SSB.

### II NR PDCCH and CORESET

Physical Downlink Control Channel (PDCCH) carries Downlink Control Information (DCI). PDCCHs are transmitted in Control Resource Sets (CORESETs) which span over one, two, or three contiguous OFDM symbols over multiple Resource Blocks (RBs). In frequency domain, a CORESET can span over one or multiple chunks of 6 RBs. For CORESETs other than CORESET #0, multiple chunks of 6 RBs can be either contiguous or non-contiguous, and the starting RB of a CORESET is determined based on section 10.1 in 3GPP TS 36.213 v17.3.0, which results in an aligned six-RB grid for the CORESETs a User Equipment (UE) is configured to monitor. CORESET #0, which is configured during the initial access, can only have 24, 48, or 96 RBs. Also, CORESET #0 must be contiguous in frequency domain, and it is not necessarily aligned with the six-RB grid.

A PDCCH is carried by 1, 2, 4, 8 or 16 Control Channel Elements (CCEs). One or more CCEs used for transmission a DCI is referred to as an Aggregation Level (AL). Each CCE is composed of 6 Resource Element Groups (REGs), and each REG is 12 Resource Elements (REs) in one OFDM symbol, as shown in FIG. 2. A REG bundle consists of 2, 3, or 6 REGs. Thus, a CCE can be composed of one or multiple bundles. 3GPP TS 38.211 contains further description of the “PDCCH” in clause 7.3.2. FIG. 2 is an illustrative example of a CORESET (48 RBs and one symbol).

Each CORESET is associated with a CCE-to-REG mapping which can be interleaved or non-interleaved. In the non-interleaved case, all CCEs in an AL are mapped in consecutive REG bundles of the associated CORESET. In the interleaved case, REG bundles of CCEs are distributed on the frequency domain over the entire CORESET bandwidth (BW). For CORESET #0, the CCE-REG mapping is always interleaved with predefined parameters.

### A CCE Indices for PDCCH Candidates

In order to receive DCI, a UE needs to blindly decode PDCCH candidates potentially transmitted from the network using one or more search spaces. A search space consists of a set of PDCCH candidates where each PDCCH candidate can occupy multiple CCEs. The number of CCEs used for a PDCCH candidate is referred to as AL which in NR can be 1, 2, 4, 8, or 16. A higher AL provides higher coverage but typically requires a larger bandwidth.

Which CCEs to use for a certain PDCCH candidate is determined by a hash function which is described in 3GPP TS 38.213 v17.3.0 as follows:
For a search space set s associated with CORESET p, the CCE indexes for aggregation level L corresponding to PDCCH candidate

$${m}_{s , {n}_{CI}}$$

of the search space set in slot

$${n}_{s , f}^{μ}$$

for an active DL BWP of a serving cell corresponding to carrier indicator field value n_{CI} are given by

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ {N}_{CCE , p} / L ⌋ \} + i$$

where
for any CSS,

$${Y}_{p , {n}_{s , f}^{μ}} = 0 ;$$

for a USS,

$${Y}_{p , {n}_{s , f}^{μ}} = ( {A}_{p} \cdot {Y}_{p , {n}_{s , f}^{μ} - 1} ) mod D ,$$

Y_{p,-1}=n_{RNTI}≠0, Aₚ≠39827 for p mod 3=0, Aₚ=39829 for p mod 3=1, Aₚ=39839 for p mod 3=2, and D=65537;
i=0, . . . , L−1;
N_{CCE,p} is the number of CCEs, numbered from 0 to N_{CCE,p}−1, in CORESET p;
n_{CI} is the carrier indicator field value if the UE is configured with a carrier indicator field by CrossCarrierSchedulingConfig for the serving cell on which PDCCH is monitored; otherwise, including for any CSS, n_{CI}=0;

$${m}_{s , {n}_{CI}} = 0 , … , {M}_{s , {n}_{CI}}^{( L )} - 1 , where {M}_{s , {n}_{CI}}^{( L )}$$

is the number of PDCCH candidates the UE is configured to monitor for aggregation level L of a search space set s for a serving cell corresponding to n_{CI};
for any CSS,

$${M}_{s , max}^{( L )} = {M}_{s , 0}^{( L )} ;$$

for a USS,

$${M}_{s , max}^{( L )}$$

is the maximum of

$${M}_{s , {n}_{CI}}^{( L )}$$

over all configured n_{CI} values for a CCE aggregation level L of search space set s;
the RNTI value used for n_{RNTI} is the C-RNTI.

The above procedure establishes, for each PDCCH candidate with aggregation level L that the UE is required to monitor in a search space, the associated set of L CCEs, and thus the corresponding REGs and REs, to which the PDCCH candidate is mapped. When non-interleaved mapping is used, these L CCEs are confined to a localized set of RBs, where the number of RBs depends on the number of OFDM symbols configured for the CORESET.

### B CCE-to-REG Mapping

A UE can be configured with multiple CORESETs. Each CORESET is associated with one CCE-to-REG mapping only. Both interleaved and non-interleaved mappings can be used. For non-interleaved mapping, all CCEs for a DCI with AL L are mapped in consecutive REG bundles of the associated CORESET. For interleaved mapping, each CCE is split in frequency domain to provide diversity.

According to 3GPP TS 38.213, the CCE-to-REG mapping is determined as follows:
REG bundle i is defined as REGs {iL, iL+1, . . . , iL+L−1} where L is the REG bundle size,

$$i = 0 , 1 , … , {N}_{R E G}^{C O R E S E T} / L - 1 , and {N}_{R E G}^{C O R E S E T} = {N}_{R B}^{CORESET} {N}_{s y m b}^{CORESET}$$

is the number of REGs in the CORESET
CCEⱼ consists of REG bundles {f(6j/L), f(6j/L+1), . . . , f(6j/L+6/L−1)} where f(⋅) is an interleaver

For non-interleaved CCE-to-REG mapping, L=6 and f(x)=x.

For interleaved CCE-to-REG mapping, considering N_{symb}^{CORESET} the CORESET duration,

$$L ∈ \{ 2 , 6 \} {N}_{s y m b}^{C O R E S E T} = 1 and L ∈ \{ {N}_{s y m b}^{CORESET} , 6 \} for {N}_{s y m b}^{C O R E S E T} ∈ \{ 2 , 3 \} .$$

The interleaver is defined by:

$$\begin{matrix}f ( x ) = ( r C + c + {n}_{shift} ) mod ( {N}_{R E G}^{C O R E S E T} / L ) \\ x = cR + r \\ r = 0 , 1 , … , R - 1 \\ c = 0 , 1 , … , C - 1 \\ C = {N}_{R E G}^{C O R E S E T} / ( LR )\end{matrix}$$

where R∈{2,3,6}.
L equals 6 for non-interleaved mapping
n_{shift}∈{0, 1, . . . , 274} is given by the higher-layer parameter shiftIndex if provided, otherwise

$${n}_{shift} = {N}_{I D}^{cell}$$

(cell ID);
For CORESET #0 interleaved mapping is used with the following parameters: L=6; R=2;

$${n}_{shift} = {N}_{I D}^{cell} .$$

### C CORESET #0

Within CORESET #0, a UE searches for the Type0-PDCCH common search space to find the System Information Block 1 (SIB1) scheduling information. For Common Search Spaces (CSSs) Type 0/Type0A/Type2, the possible ALs are: 4, 8, and 16. For each AL, there can be one or multiple possible candidates as listed in Table 2. CORESET #0 can have different configurations, spanning 24, 48, or 96 RBs in frequency and 1-3 OFDM symbols in time (See Table 3, copied from Tables 13-1 in 3GPP TS 38.213, Section 13) where the UE assumes that the offset in Table 3 is defined with respect to the subcarrier spacing (SCS) of the CORESET for Type0-PDCCH CSS set from the smallest RB index of the CORESET for Type0-PDCCH CSS set to the smallest RB index of the common RB overlapping with the first RB of the corresponding SS/PBCH block.

See FIG. 3 for an illustration of CORESET #0 position with respect to SSB as a result of the offset parameter. Note that possible values of Offset (RBs) in Table 3 are 0, 2, and 4 RBs. By definition, the first RB of CORESET #0 is always positioned lower in frequency domain compared to the common RB with lowest index overlapping with the SSB. In other words, FIG. 3 is an illustration of CORESET #0 position with respect to SSB. Offset (RBs) is the offset in RBs from the smallest RB index of the CORESET #0 to the smallest RB index of the common RB overlapping with the first RB of the corresponding SSB. Note that the common RB with smallest RB index overlapping with SSB is not necessarily the same as the first RB of the SSB. Its location is defined by the higher-layer parameter ssh-SubcarrierOffset (k_{SSB}) which is the subcarrier offset from subcarrier 0 of the common RB to subcarrier 0 of the SSB.

TABLE 2
Number of PDCCH candidates for
Type 0/Type0A/Type2 CSS (in NR)

| | Maximum number of PDCCH |
|---|---|
| Aggregation | candidates for common search |
| level | space |
| 4 | 4 |
| 8 | 2 |
| 16 | 1 |

TABLE 3
Set of resource blocks and slot symbols of CORESET for Type0-PDCCH search space
set when {SS/PBCH block, PDCCH} SCS is {15, 15} kHz for frequency bands with minimum
channel bandwidth 5 MHz or 10 MHz

| | | Number of | Number of | |
|---|---|---|---|---|
| | SS/PBCH block and | RBs | Symbols | |
| Index | CORESET multiplexing pattern | ${N}_{R B}^{CORESET}$ | ${N}_{s y m b}^{CORESET}$ | Offset (RBs) |
| 0 | 1 | 24 | 2 | 0 |
| 1 | 1 | 24 | 2 | 2 |
| 2 | 1 | 24 | 2 | 4 |
| 3 | 1 | 24 | 3 | 0 |
| 4 | 1 | 24 | 3 | 2 |
| 5 | 1 | 24 | 3 | 4 |
| 6 | 1 | 48 | 1 | 12 |
| 7 | 1 | 48 | 1 | 16 |
| 8 | 1 | 48 | 2 | 12 |
| 9 | 1 | 48 | 2 | 16 |
| 10 | 1 | 48 | 3 | 12 |
| 11 | 1 | 48 | 3 | 16 |
| 12 | 1 | 96 | 1 | 38 |
| 13 | 1 | 96 | 2 | 38 |
| 14 | 1 | 96 | 3 | 38 |

| | |
|---|---|
| 15 | Reserved |

As discussed earlier, the current NR CORESET #0 only supports interleaved CCE-REG mapping. Therefore, CCEs carrying PDCCH candidates are spread over the entire CORESET #0 frequency allocation.

### SUMMARY

Systems and methods are disclosed that are related to puncturing of Control Resource Set (CORESET) #0, e.g., for operation in a narrow channel bandwidth. In one embodiment, a method performed by a User Equipment (UE) comprises operating in a wireless spectrum allocation that is smaller than an amount of frequency domain resources needed for receiving a Synchronization Signal (SS)/Physical Broadcast Channel (PBCH) block (SSB) and CORESET #0. The method further comprises receiving, from a network node, the SSB and the CORESET #0 after puncturing at the network node, wherein puncturing of the SSB is determined by a number of resource blocks (RBs) comprised in the wireless spectrum allocation within a respective frequency band and puncturing of a Physical Downlink Control Channel (PDCCH) mapped to the CORESET #0 is determined by the puncturing of the SSB and one or more offset parameters. The method further comprises decoding a message based on the PBCH or the PDCCH mapped to the CORESET #0. In this manner, impact of puncturing on the SB and PDCCH mapped to CORESET #0 on performance is reduced.

In one embodiment, the wireless spectrum allocation is a New Radio (NR) spectrum allocation.

In one embodiment, the one or more offset parameters comprises a SSB subcarrier offset, an offset in a configuration of the CORESET #0, or both the SSB subcarrier offset and the offset in the configuration of the CORESET #0.

In one embodiment, a Primary Synchronization Signal (PSS) and Secondary Synchronization Signal (SSS) comprised in the SSB are unpunctured. In one embodiment, the PBCH is punctured, and the puncturing of the PBCH depends on which of a set of candidate SSBs is transmitted by the network node as the SSB.

In one embodiment, puncturing of the SSB is given by a number of RBs comprised in the wireless spectrum allocation, where a location of the RBs within a respective frequency band determines a set of candidate SSBs to consider depending on a location of a respective synchronization raster, wherein among the set of candidate SSBs only one or more of the candidate SSBs that preserve a PSS and SSS unpunctured are selected as an ultimate selection of the SSB(s) transmitted by the network node in the wireless spectrum allocation. Further, the puncturing of the SSSB is such that, while the PSS and the SSS are fully preserved, the PBCH is partially preserved, wherein how much of the PBCH is preserved outside a region of the SSB that contains the PSS/SSS depends on the ultimate selection of the SSB(s) transmitted by the network node in the wireless spectrum.

In one embodiment, the method further comprises receiving, from a network node, information that indicates an offset for CORESET #0, wherein the offset is defined as a number of RBs from a lowest RB of the CORESET #0 to a first common RB overlapping with the SSB, and the indicated offset for CORESET #0 is one of a predefined set of offsets that comprises one or more negative values. In one embodiment, the first common RB overlapping with the SSB is a common RB overlapping with SSB having a smallest RB index. In one embodiment, the first common RB overlapping with the SSB is not necessarily the same as a first RB of the SSB. In one embodiment, a location of the first common RB overlapping with the SSB is defined by a higher-layer parameter which is the subcarrier offset from subcarrier 0 of the first common RB to subcarrier 0 of the SSB. In one embodiment, the predefined set of offsets further comprises one or more positive values. In one embodiment, the predefined set of offsets is defined in a defined table for operation with a channel bandwidth of less than 5 MHz. In one embodiment, the predefined set of offsets is defined in a defined table that comprises one or more positive offset values and the one or more negative offset values. In one embodiment, the predefined set of offsets is defined in a defined table in which one or more previously unused entries in the defined table are used to define the one or more negative offset values.

In one embodiment, the method further comprises receiving, from a network node, information that indicates an offset for CORESET #0, wherein the offset is defined as a number of RBs from the first common RB overlapping with the SSB to the lowest RB of the CORESET #0, and the indicated offset for the CORESET #0 is one of a predefined set of offsets comprising only one or more positive offset values. In one embodiment, the first common RB overlapping with the SSB is a common RB overlapping with SSB having a smallest RB index. In one embodiment, the first common RB overlapping with the SSB is not necessarily the same as a first RB of the SSB. In one embodiment, a location of the first common RB overlapping with the SSB is defined by a higher-layer parameter which is the subcarrier offset from subcarrier 0 of the first common RB to subcarrier 0 of the SSB. In one embodiment, whether the offset is defined as a number of RBs from the first common RB overlapping with SSB to the lowest RB of the CORESET #0 or defined as a number of RBs from the lowest RB of the CORESET #0 to the first common RB overlapping with the SSB and the indicated offset for CORESET #0 is configurable or indicated by the network node.

In one embodiment, the method further comprises receiving, from a network node, information that indicates an offset for CORESET #0, wherein the offset is defined as number of RBs from the lowest RB of the CORESET #0 to a common RB overlapping with a new reference point of the SSB. In one embodiment, the new reference point is a certain subcarrier index other than a lowest index of the SSB. In one embodiment, the new reference point is either fixed or configurable by the network node. In one embodiment, the new reference point is a synchronization raster or a subcarrier number #120 of the SSB. In one embodiment, the new reference point is a subcarrier number #48 of the SSB.

In one embodiment, the method further comprises performing one or more actions using the CORESET #0 in accordance with the indicated offset. In one embodiment, performing the one or more actions comprises the decoding the message based on the PBCH or the PDCCH mapped to the CORESET #0.

In one embodiment, a channel bandwidth of the wireless spectrum allocation in which the CORESET #0 is transmitted is less than or equal to 5 MHz.

In one embodiment, a channel bandwidth of the wireless spectrum allocation in which the CORESET #0 is transmitted is in a range of and including 3 MHz to 5 MHz.

Corresponding embodiments of a UE are also disclosed. In one embodiment, a UE is adapted to operate in a wireless spectrum allocation that is smaller than an amount of frequency domain resources needed for receiving an SSB and CORESET #0. The UE is further adapted to receive, from a network node, an SSB and CORESET #0 after being punctured at the network node, wherein puncturing of the SSB is determined by a number of RBs comprised in the wireless spectrum allocation within a respective frequency band and puncturing of a PDCCH mapped to the CORESET #0 is determined by the puncturing of the SSB and one or more offset parameters. The UE is further adapted to decode a message based on the PBCH or a PDCCH mapped to the CORESET #0.

In one embodiment, a UE comprises a communication interface comprising a transmitter and a receiver, and processing circuitry associated with the communication interface. The processing circuitry is configured to cause the UE to operate in a wireless spectrum allocation that is smaller than an amount of frequency domain resources needed for receiving an SSB and CORESET #0. The processing circuitry is further configured to cause the UE to receive, from a network node, an SSB and CORESET #0 after being punctured at the network node, wherein puncturing of the SSB is determined by a number of RBs comprised in the wireless spectrum allocation within a respective frequency band and puncturing of a PDCCH mapped to the CORESET #0 is determined by the puncturing of the SSB and one or more offset parameters. The processing circuitry is further configured to cause the UE to decode a message based on the PBCH or a PDCCH mapped to the CORESET #0.

In another embodiment, a method performed by a UE that operates on a wireless channel comprises receiving, from a network node, downlink control information (DCI) that schedules a broadcast Physical Downlink Shared Channel (PDSCH), wherein the DCI comprises a frequency domain resource assignment for the broadcast PDSCH that is applied with respect to a size of a reference frequency domain resource of CORESET #0 for broadcast PDSCH scheduling, a frequency-domain size of CORESET #0 exceeds a bandwidth of the wireless channel on which the UE operates, and the reference frequency domain resource of CORESET #0 for broadcast PDSCH scheduling is confined within the bandwidth of the wireless channel on which the UE operates. The method further comprises receiving the scheduled PDSCH in accordance with the DCI.

In one embodiment, CORESET #0 is punctured.

In one embodiment, the reference frequency domain resource of CORESET #0 for broadcast PDSCH scheduling is equal to a channel bandwidth defined based on an associated transmission bandwidth configuration.

In one embodiment, the reference frequency domain resource of CORESET #0 for broadcast PDSCH scheduling is equal to a bandwidth of the wireless channel on which the UE operates.

In one embodiment, the reference frequency domain resource of CORESET #0 for broadcast PDSCH scheduling is a reference frequency domain resource of CORESET #0 that is different than a reference frequency domain resource of CORESET #0 used for PDCCH candidate mapping if the frequency domain resource for CORESET #0 is not greater than a respective channel bandwidth.

In one embodiment, the new reference frequency domain resource of CORESET #0 is fully contained within the respective channel bandwidth.

In one embodiment, the reference frequency domain resource of CORESET #0 for broadcast PDSCH scheduling consists of all contiguous physical resource blocks (PRBs) that are confined within the bandwidth of the wireless channel on which the UE operates.

In one embodiment, a size of the reference frequency domain resource of CORESET #0 for broadcast PDSCH scheduling is smaller than the bandwidth of the wireless channel, and the reference frequency domain resource of CORESET #0 for broadcast PDSCH scheduling is positioned within the bandwidth of the wireless channel such that its lowest physical resource block, PRB, index is aligned with a lowest PRB index of the wireless channel.

In one embodiment, a size of the reference frequency domain resource of CORESET #0 for broadcast PDSCH scheduling is smaller than that of the bandwidth of the wireless channel, and the reference frequency domain resource of CORESET #0 for broadcast PDSCH scheduling is positioned within the bandwidth of the wireless channel such that its highest physical resource block, PRB, index is aligned with a highest PRB index of the wireless channel.

Corresponding embodiments of a UE are also disclosed. In one embodiment, a UE that operates on a wireless channel is adapted to receive, from a network node, DCI that schedules a broadcast PDSCH, wherein the DCI comprises a frequency domain resource assignment for the broadcast PDSCH that is applied with respect to a size of a reference frequency domain resource of CORESET #0 for broadcast PDSCH scheduling, a frequency-domain size of CORESET #0 exceeds a bandwidth of the wireless channel on which the UE operates, and the reference frequency domain resource of CORESET #0 for broadcast PDSCH scheduling is confined within the bandwidth of the wireless channel on which the UE operates. The UE is further adapted to receive the scheduled PDSCH in accordance with the DCI.

In one embodiment, a UE for operation on a wireless channel comprises a communication interface comprising a transmitter and a receiver, and processing circuitry associated with the communication interface. The processing circuitry is configured to cause the UE to receive, from a network node, DCI that schedules a broadcast PDSCH, wherein the DCI comprises a frequency domain resource assignment for the broadcast PDSCH that is applied with respect to a size of a reference frequency domain resource of CORESET #0 for broadcast PDSCH scheduling, a frequency-domain size of CORESET #0 exceeds a bandwidth of the wireless channel on which the UE operates, and the reference frequency domain resource of CORESET #0 for broadcast PDSCH scheduling is confined within the bandwidth of the wireless channel on which the UE operates. The processing circuitry is further configured to cause the UE to receive the scheduled PDSCH in accordance with the DCI.

In another embodiment, a method performed by a UE that operates on a wireless channel comprises receiving, from a network node, information that configures one or more parameters related to CORESET #0, the one or more parameters comprising a frequency domain resource allocation for the CORESET #0 and determining that the frequency domain resource allocation for the CORESET #0 is greater than a respective channel bandwidth. The method further comprises, responsive to determining that the frequency domain resource allocation for the CORESET #0 is greater than the respective channel bandwidth, performing PDCCH candidate mapping for the CORESET #0 with respect to a new reference frequency domain resource of the CORESET #0. The method further comprises searching one or more PDCCH candidates within the CORESET #0 in accordance with the PDCCH candidate mapping for CORESET #0 with respect to the new reference frequency domain resource of CORESET #0.

In one embodiment, the new reference frequency domain resource of the CORESET #0 is a reference frequency domain resource of the CORESET #0 that is different than a reference frequency domain resource of CORESET #0 used for PDCCH candidate mapping if the frequency domain resource allocation for the CORESET #0 is not greater than the respective channel bandwidth.

In one embodiment, the new reference frequency domain resource of the CORESET #0 is fully contained within the respective channel bandwidth.

In one embodiment, the new reference frequency domain resource of the CORESET #0 consists of all contiguous PRBs that are confined within the respective channel bandwidth.

In one embodiment, a size of the new reference frequency domain resource is smaller than that of the respective channel bandwidth, and the new reference frequency domain resource is positioned within the respective channel bandwidth such that its lowest physical resource block, PRB, index is aligned with a lowest PRB index of the respective channel bandwidth.

In one embodiment, a size of the new reference frequency domain resource is smaller than that of the respective channel bandwidth, and the new reference frequency domain resource is positioned within the respective channel bandwidth such that its highest physical resource block, PRB, index is aligned with a highest PRB index of the respective channel bandwidth.

Corresponding embodiment of a UE are also disclosed. In one embodiment, a UE is adapted to receive, from a network node, information that configures one or more parameters related to CORESET #0, the one or more parameters comprising a frequency domain resource allocation for the CORESET #0 and determining that the frequency domain resource allocation for the CORESET #0 is greater than a respective channel bandwidth. The UE is further adapted to, responsive to determining that the frequency domain resource allocation for the CORESET #0 is greater than the respective channel bandwidth, perform PDCCH candidate mapping for the CORESET #0 with respect to a new reference frequency domain resource of the CORESET #0. The UE is further adapted to search one or more PDCCH candidates within the CORESET #0 in accordance with the PDCCH candidate mapping for CORESET #0 with respect to the new reference frequency domain resource of CORESET #0.

In another embodiment, a method performed by a UE that operates on a wireless channel comprises receiving, from a network node, information that configures an initial downlink bandwidth part (BWP) in accordance with one or more relaxed restrictions on the initial downlink BWP relative to CORESET #0, and performing one or more actions using the initial downlink BWP. For NR operation with narrow channel bandwidth of approximately 3 MHz to less than 5 MHz, either: the relaxed restrictions are such that the initial downlink BWP may not contain all PRBs of the CORESET #0 or the relaxed restrictions are such that the initial downlink BWP still needs to be configured such that it contains all physical resource blocks, PRBs, of the CORESET #0 but the CORESET #0 may be punctured.

Embodiments of a method served by a network node are also disclosed. In one embodiment, a method performed by a network node comprises serving a UE in a wireless spectrum allocation that is smaller than frequency domain resources needed for reception by the UE of a SSB and CORESET #0, and transmitting an SSB and a PDCCH mapped to the CORESET #0 after puncturing, wherein puncturing of the SSB is determined by a number of RBs comprised in the wireless spectrum allocation within a respective frequency band and puncturing of a PDCCH mapped to the CORESET #0 is determined by the puncturing of the SSB and one or more offset parameters.

In one embodiment, the wireless spectrum allocation is an NR spectrum allocation.

In one embodiment, the one or more offset parameters comprises a SSB subcarrier offset, an offset in a configuration of the CORESET #0, or both the SSB subcarrier offset and the offset in the configuration of the CORESET #0.

In one embodiment, a PSS and SSS comprised in the SSB are unpunctured. In one embodiment, the PBCH is punctured, and the puncturing of the PBCH depends on which of a set of candidate SSBs is transmitted by the network node as the SSB.

In one embodiment, puncturing of the SSB is given by a number of RBs comprised in the wireless spectrum allocation, where a location of the RBs within a respective frequency band determines a set of candidate SSBs to consider depending on a location of a respective synchronization raster, wherein among the set of candidate SSBs only one or more of the candidate SSBs that preserve a PSS and SSS unpunctured are selected as an ultimate selection of the SSB(s) transmitted by the network node in the wireless spectrum allocation. The puncturing of SSB is further given by, while the PSS and the SSS are fully preserved, the PBCH is partially preserved, wherein how much of the PBCH is preserved outside a region of the SSB that contains the PSS/SSS depends on the ultimate selection of the SSB(s) transmitted by the network node in the wireless spectrum.

In one embodiment, a channel bandwidth of the wireless spectrum allocation is less than or equal to 5 MHz.

In one embodiment, a channel bandwidth of the wireless spectrum allocation is in a range of and including 3 MHz to 5 MHz.

Corresponding embodiments of a network node are also disclosed. In one embodiment, a network node is adapted to serve a UE in a wireless spectrum allocation that is smaller than frequency domain resources needed for reception by the UE of a SSB and CORESET #0, and transmit an SSB and a PDCCH mapped to the CORESET #0 after puncturing, wherein puncturing of the SSB is determined by a number of RBs comprised in the wireless spectrum allocation within a respective frequency band and puncturing of a PDCCH mapped to the CORESET #0 is determined by the puncturing of the SSB and one or more offset parameters.

In another embodiment, a method performed by a network node for serving a UE that operates on a wireless channel comprises transmitting, to the UE, DCI that schedules a broadcast PDSCH, wherein the DCI comprises a frequency domain resource assignment for the broadcast PDSCH that is applied with respect to a size of a reference frequency domain resource of CORESET #0 for broadcast PDSCH scheduling, a frequency-domain size of CORESET #0 exceeds a bandwidth of the wireless channel on which the UE operates, and the reference frequency domain resource of CORESET #0 for broadcast PDSCH scheduling is confined within the bandwidth of the wireless channel on which the UE operates. The method further comprises transmitting the scheduled PDSCH in accordance with the DCI.

In one embodiment, the reference frequency domain resource of CORESET #0 for broadcast PDSCH scheduling is equal to a channel bandwidth defined based on an associated transmission bandwidth configuration.

In one embodiment, the reference frequency domain resource of CORESET #0 for broadcast PDSCH scheduling is equal to a bandwidth of the wireless channel on which the UE operates.

Corresponding embodiments of a network node are also disclosed. In one embodiment, a network node for serving a UE that operates on a wireless channel is adapted to transmit, to the UE, DCI that schedules a broadcast PDSCH, wherein the DCI comprises a frequency domain resource assignment for the broadcast PDSCH that is applied with respect to a size of a reference frequency domain resource of CORESET #0 for broadcast PDSCH scheduling, a frequency-domain size of CORESET #0 exceeds a bandwidth of the wireless channel on which the UE operates, and the reference frequency domain resource of CORESET #0 for broadcast PDSCH scheduling is confined within the bandwidth of the wireless channel on which the UE operates. The network node is further adapted to transmit the scheduled PDSCH in accordance with the DCI.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates the time-frequency structure of a Synchronization Signal (SS)/Physical Broadcast Channel (PBCH) block (i.e., an SSB) as defined in 3^{rd} Generation Partnership Project (3GPP) New Radio (NR) specifications;

FIG. 2 is an illustrative example of a Control Resource Set (CORESET) (48 Resource Blocks (RBs) and one symbol);

FIG. 3 is an illustration of CORESET #0 position with respect to SSB;

FIG. 4 illustrates the operation of a User Equipment (UE) in accordance with a puncturing strategy for reduced channel bandwidth, in accordance with one embodiment of the present disclosure;

FIG. 5 illustrates the operation of a network node in accordance with a puncturing strategy for reduced channel bandwidth, in accordance with one embodiment of the present disclosure;

FIG. 6 illustrates an example of when negative offset value is applied to determine CORESET #0 position with respect to the corresponding SSB, in accordance with one embodiment of the present disclosure;

FIG. 7 illustrates an example of when the offset value is applied with respect to a new reference point of the corresponding SSB, in accordance with one embodiment of the present disclosure;

FIG. 8 illustrates an example of when the offset value is applied with respect to a new reference point of the corresponding SSB, in accordance with one embodiment of the present disclosure;

FIG. 9 illustrates the operation of a network node and a UE in relation to CORESET #0 positioning with respect to SSB, in accordance with at least some embodiments;

FIG. 10 illustrates an example of performance of Physical Downlink Control Channel (PDCCH) reception in terms of Block Error Rate (BLER) vs. Signal to Noise Ratio (SNR);

FIG. 11(a) illustrates the case where the PDCCH candidate with 8 Control Channel Elements (CCEs) is punctured due to the narrow channel bandwidth, i.e., 3 CCEs are punctured and only 5 remaining CCEs are transmitted by the base station and received by the UE. FIG. 11(b) illustrates an alternative PDCCH candidate mapping where the candidate is mapped to the 5-CCE region which are confined within the narrow channel bandwidth without any puncturing;

FIG. 12 illustrates an example where a new reference frequency domain resource for CORSET #0 is of total size smaller than the narrow channel bandwidth, in accordance with one embodiment of the present disclosure;

FIG. 13 illustrates an example where a new reference frequency domain resource for CORESET #0 is of total size smaller than the narrow channel bandwidth, in accordance with one embodiment of the present disclosure;

FIG. 14 illustrates the operation of a network node and a UE for modified PDCCH candidate mapping onto CORESET #0, in accordance with at least some embodiments of the present disclosure;

FIG. 15 illustrates the operation of a network node and a UE for scheduling of broadcast Physical Downlink Shared Channel (PDSCH) based on CORESET #0, in accordance with at least some embodiments of the present disclosure;

FIG. 16 illustrates the description of the restriction of the initial downlink (DL) bandwidth part (BWP) configuration which should contain the entire CORESET #0 as defined in 3GPP Technical Specification (TS) 38.331;

FIG. 17 illustrates the operation of a network node and a UE in relation to relaxation of BWP constraints related to CORESET #0, in accordance with at least some of embodiments of the present disclosure;

FIG. 18 shows an example of a communication system in accordance with some embodiments;

FIG. 19 shows a UE in accordance with some embodiments;

FIG. 20 shows a network node in accordance with some embodiments;

FIG. 21 is a block diagram of a host, which may be an embodiment of the host of FIG. 18, in accordance with various aspects described herein;

FIG. 22 is a block diagram illustrating a virtualization environment in which functions implemented by some embodiments may be virtualized; and

FIG. 23 shows a communication diagram of a host communicating via a network node with a UE over a partially wireless connection in accordance with some embodiments.

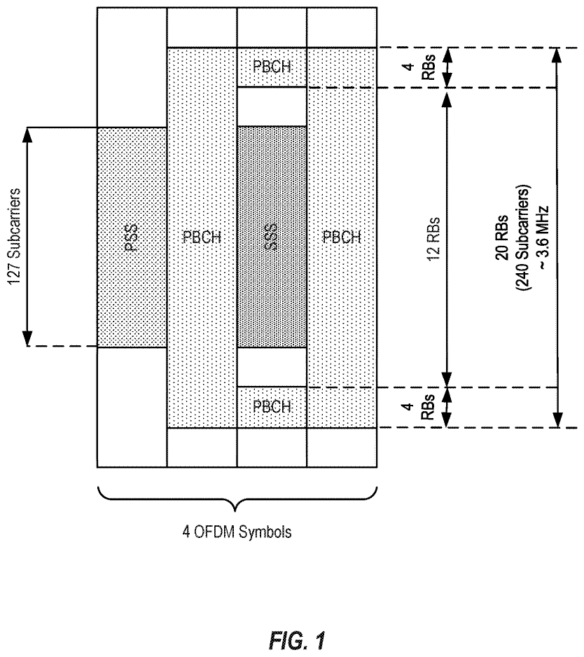

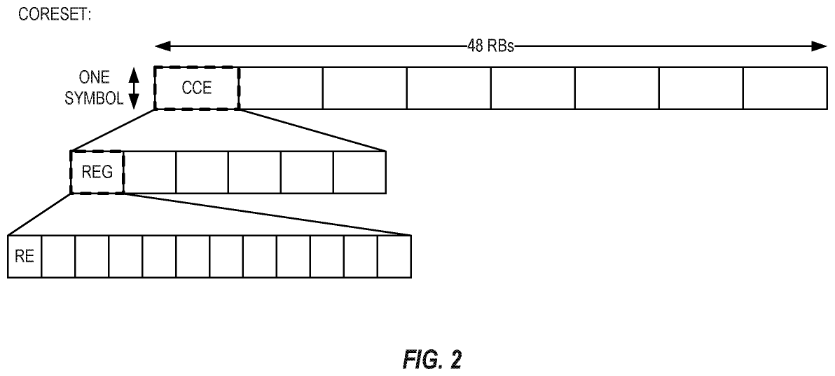

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenge(s). 3^{rd} Generation Partnership (3GPP) New Radio (NR) operations with narrow bandwidth from approximately 3 Megahertz (MHz) to less than 5 MHz based on existing physical channel and signal structures will result in some performance loss due to Physical Resource Block (PRB) puncturing. For example, the smallest frequency domain allocation of the existing Control Resource Set (CORESET) #0 (i.e., CORESET #0) configurations is 24 PRBs. If 15 PRBs is considered as available PRBs excluding guardbands for the 3 MHz channel bandwidth (as an example of the narrow bandwidth from approximately 3 MHz to less than 5 MHz), then 9 PRBs of the CORESET #0 will be punctured. A Physical Downlink Control Channel (PDCCH) candidate mapped onto CORESET #0 follows the mappings defined in the 3GPP specifications. The impact of PRB puncturing depends on which Control Channel Elements (CCEs) are mapped for the PDCCH candidate. Currently, there is little flexibility in the specifications for such mapping and how CORESET #0 can be positioned with respect to the corresponding Synchronization Signal Block (SSB). This implies that there is little flexibility for the network to avoid performance loss on PDCCH reception due to PRB puncturing of CORESET #0.

Moreover, in NR, some broadcast Physical Downlink Shared Channels (PDSCHs) are scheduled with frequency domain resources based on the size of CORESET #0. Without any scheduling restriction, this can lead to scenarios where the scheduled broadcast PDSCH is also punctured.

Certain aspects of the disclosure and their embodiments may provide solutions to these or other challenges. Systems and methods are disclosed herein that provide solutions to support NR operation for reduced channel bandwidth applications in new dedicated spectrums. In particular, systems and methods disclosed herein provide more flexibility for how CORESET #0 can be positioned with respect to the SSB and how a PDCCH candidate can be mapped onto CORESET #0 in a way that reduces the impact from PRB puncturing.

Embodiments of the present disclosure include one or more of the following aspects:
Principles of puncturing on CORESET #0 and SS/Physical Broadcast Channel (PBCH) block (SS/PBCH block is also referred to herein as “SSB”);
New negative offset values for CORESET #0 position with respect to SSB position (Section 2 below);
New reference point to apply for the existing offset values for CORESET #0 position with respect to SSB position (Section 2 below);
New reference frequency domain resources of CORESET #0 for PDCCH candidate mapping to reduce the impact of PRB puncturing of CORESET #0 (Section 3 below);
New reference frequency domain resources of CORESET #0 for broadcast PDSCH scheduling (Section 4 below).

Certain embodiments may provide one or more of the following technical advantage(s). For embodiments of the proposed solutions, the following advantages may be provided:
Providing flexibility for PDCCH transmission in a CORESET #0 in NR operations with narrow channel bandwidth of less than 5 MHz;
Reducing impact of PRB puncturing on PDCCH reception performance in CORESET #0, e.g., the solutions can allow PDCCH candidate mapping with minimum number of impacted CCEs or Resource Element Group (REG) bundles from PRB puncturing;
Avoiding impact of PRB puncturing on broadcast PDSCH of which the frequency domain resources are scheduled based on CORESET #0.

In the present disclosure, different embodiments are described that are related to CORESET #0 for NR operation with narrow channel bandwidth of less than 5 MHz. Even though, in some embodiments, examples are given for a certain channel bandwidth size, e.g., 3 MHz, the embodiments are generally applicable to any channel bandwidth size of less than 5 MHz.

Although the embodiments are described for NR operation with narrow channel bandwidth from the perspective of limited spectrum availability, they are also applicable to the NR operations where the bandwidth size is restricted due to limited User Equipment (UE) capability, e.g., when the maximum supported UE bandwidth is reduced. That is, the solutions described herein are not strictly tied to the Rel-18 feature on “NR support for dedicated spectrum less than 5 MHz for FR1”, since the solutions and concepts described here may be fully or partially used by other NR features e.g., RedCap.

When the solutions are described for the cases where CORESET #0 or SSB size is larger than the narrow channel bandwidth, they are generally applicable for the cases where the narrow channel bandwidth is with or without guardbands.

In the present disclosure, the description is focused on solutions for CORESET #0 in NR operation with narrow channel bandwidth of less than 5 MHz. The main scenario is when the narrow bandwidth size is smaller than the frequency domain resources needed for CORESET #0 and SS/PBCH block, leading to puncturing of CORESET #0 and SS/PBCH block. The general embodiments related to CORESET #0 and SS/PBCH block puncturing are provided below.

In one embodiment, the puncturing on SS/PBCH block is given by the following: The number of Resource Blocks (RBs) composing the reduced bandwidth, where their location within a given NR band will determine a set of candidate SSBs to consider depending on the location of the synchronization raster. Among those candidate SSBs, only the one(s) preserving Primary Synchronization Signal (PSS) and Secondary Synchronization Signal (SSS) unpunctured will remain to be considered.

In one dependent embodiment, while PSS/SSS is fully preserved, PBCH will be partially preserved; how much of PBCH will be preserved outside the PSS/SSS region will depend on the ultimate selection of the candidate SSB(s) mentioned in the previous embodiment.

In one embodiment, the puncturing on PDCCH which is mapped to CORESET #0 will be determined by the puncturing applied on SSB, and the offset parameters as indicated by the higher-layer parameter ssb-SubcarrierOffset (k_{SSB}) and “Offset (RBs)” in the CORESET #0 configuration.

### 1 Puncturing Strategy for Reduced Channel Bandwidth

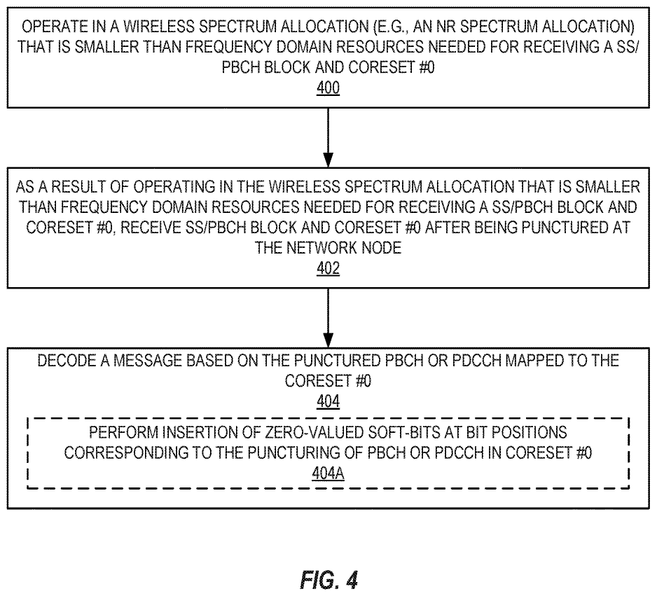

FIG. 4 illustrates the operation of a UE in accordance with a puncturing strategy for reduced channel bandwidth in accordance with one embodiment of the present disclosure. As illustrated, the UE operates in a wireless spectrum allocation (e.g., an NR spectrum allocation) that is smaller than frequency domain resources needed for receiving an SS/PBCH block and CORESET #0 (step 400). As a result of operating in the wireless spectrum allocation that is smaller than frequency domain resources needed for receiving, from a network node, an SS/PBCH block and CORESET #0, the UE receives SS/PBCH block and CORESET #0 after being punctured at the network node (step 402). The UE decodes a message based on the punctured PBCH or PDCCH mapped to the CORESET #0 (step 402). In one embodiment, decoding the message comprises performing insertion of zero-valued soft-bits at bit positions corresponding to the puncturing of PBCH or PDCCH in CORESET #0.

In one embodiment, the puncturing of the SS/PBCH block is given by the following:
a number of RBs comprised in the wireless spectrum allocation, where a location of the RBs within a respective frequency band (e.g., NR band) determines a set of candidate SSBs to consider depending on a location of a respective synchronization raster, wherein among the candidate SSBs only one or more of the candidate SSBs that preserve PSS and SSS unpunctured are selected as an ultimate selection of candidate SSB(s);
while PSS/SSS is fully preserved, PBCH is partially preserved, wherein how much of PBCH is preserved outside the PSS/SSS region depends on the ultimate selection of the candidate SSB(s).

In one embodiment, the puncturing on PDCCH which is mapped to CORESET #0 is determined by the puncturing applied on the SSB and one or more offset parameters (e.g., as indicated by a higher-layer parameter (e.g., ssb-SubcarrierOffset (kSSB)) and “Offset (RBs)” in a configuration of the CORESET #0).

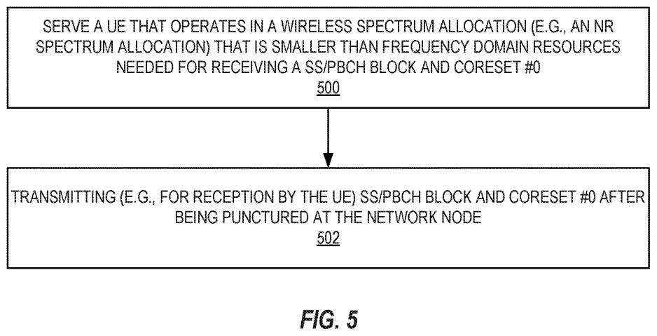

FIG. 5 illustrates the operation of a network node (e.g., a base station such as, e.g., a gNB or a RAN node that performs at least some of the functionality of a base station such as, e.g., a gNB-CU or gNB-DU), in accordance with one embodiment of the present disclosure. As illustrated, the network node serves a UE that operates in a wireless spectrum allocation (e.g., an NR spectrum allocation) that is smaller than frequency domain resources needed for receiving an SS/PBCH block and CORESET #0 (step 500). As a result of the UE operating in the wireless spectrum allocation that is smaller than frequency domain resources needed for receiving, from a network node, an SS/PBCH block and CORESET #0, the network node transmits SS/PBCH block and CORESET #0 (more specifically a PDCCH mapped to CORESET #0) (to the UE) after being punctured at the network node (step 502).

In one embodiment, the puncturing of the SS/PBCH block is given by the following:
a number of RBs comprised in the wireless spectrum allocation, where a location of the RBs within a respective frequency band (e.g., NR band) determines a set of candidate SSBs to consider depending on a location of a respective synchronization raster, wherein among the candidate SSBs only one or more of the candidate SSBs that preserve PSS and SSS unpunctured are selected as an ultimate selection of candidate SSB(s);
while PSS/SSS is fully preserved, PBCH is partially preserved, wherein how much of PBCH is preserved outside the PSS/SSS region depends on the ultimate selection of the candidate SSB(s).

In one embodiment, the puncturing on PDCCH which is mapped to CORESET #0 is determined by the puncturing applied on the SSB and one or more offset parameters (e.g., as indicated by a higher-layer parameter (e.g., ssb-SubcarrierOffset (kSSB)) and “Offset (RBs)” in a configuration of the CORESET #0).

Note that the embodiments described below in Sections 2, 3, 4, and 5 are preferably, but not necessarily, performed together with the processes of FIGS. 4 and 5. In other words, the embodiments below regarding the operation of the UE are preferably, but not necessarily, performed together with the process of FIG. 4. Likewise, the embodiments below regarding the operation of the network node are preferably, but not necessarily, performed together with the process of FIG. 5.

### 2 CORESET #0 Position with Respect to SSB

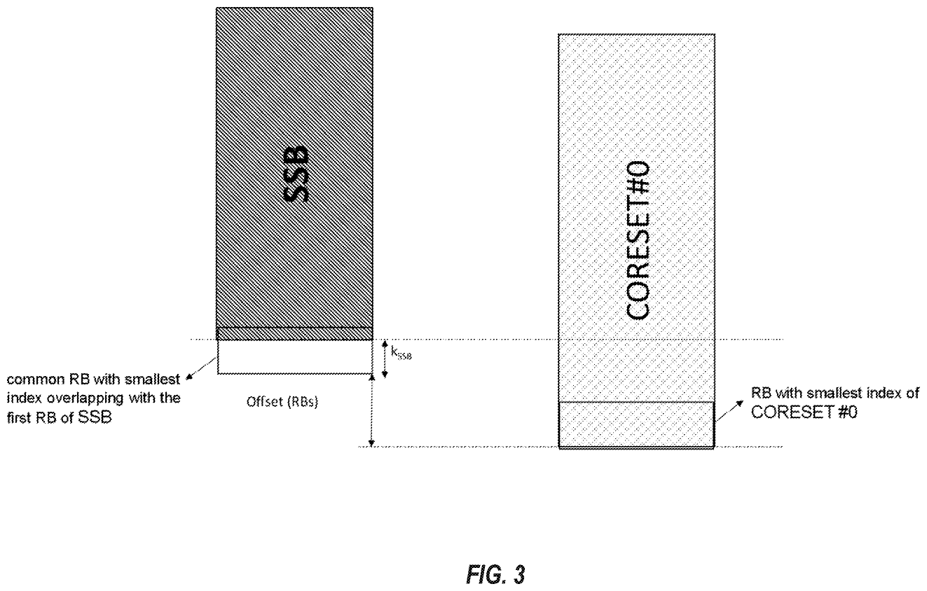

According to the current 3GPP specifications, the first (lowest) PRB of CORESET #0 is never positioned above the first PRB of the corresponding SSB. This is due to the definition of the offset value which defines an offset in RBs from the lowest RB of CORESET #0 to the first common RB overlapping with SSB (See FIG. 3). For example, for 15 kilohertz (kHz) subcarrier spacing (SCS) configuration of both SSB and CORESET #0, the existing offset values are 0, 2, and 4 RBs for the CORESET #0 of size 24 RBs.

In the following embodiments, solutions are described to add new values of the offset parameter which can be negative.

In one non-limiting embodiment, new values of the offset parameter which can be negative are introduced for NR operation with narrow channel bandwidth of less than 5 MHz. A negative offset defines an offset in RBs from the first common RB overlapping with SSB to the lowest RB of CORESET #0.

In one dependent embodiment, a new table for CORESET #0 configuration for NR operation with narrow channel bandwidth of less than 5 MHz consisting of both positive and negative offset values is introduced (See Table 4 for an illustrating example of such table containing new offset values which can be negative.).

In one dependent embodiment, the new values of the offset parameter which can be negative are introduced as additional selectable values to the existing set of positive offset values associated to the parameter “Offset (RBs)”.

In one other embodiment, alternatively the new values of the offset parameter which can be negative are introduced in an existing table (e.g., Table 13-1 in TS 38.213) either on reserved/unused entries or through re-interpreting any other entry not usable for NR operation with narrow channel bandwidth of less than 5 MHz.

In one other embodiment, whether to apply the offsets in Table 13-1 in 3GPP TS 38.213 as an offset in RBs from the first common RB overlapping with SSB to the lowest RB of CORESET #0 is indicated using the spare bit available in master information block carried by the SSB PBCH.

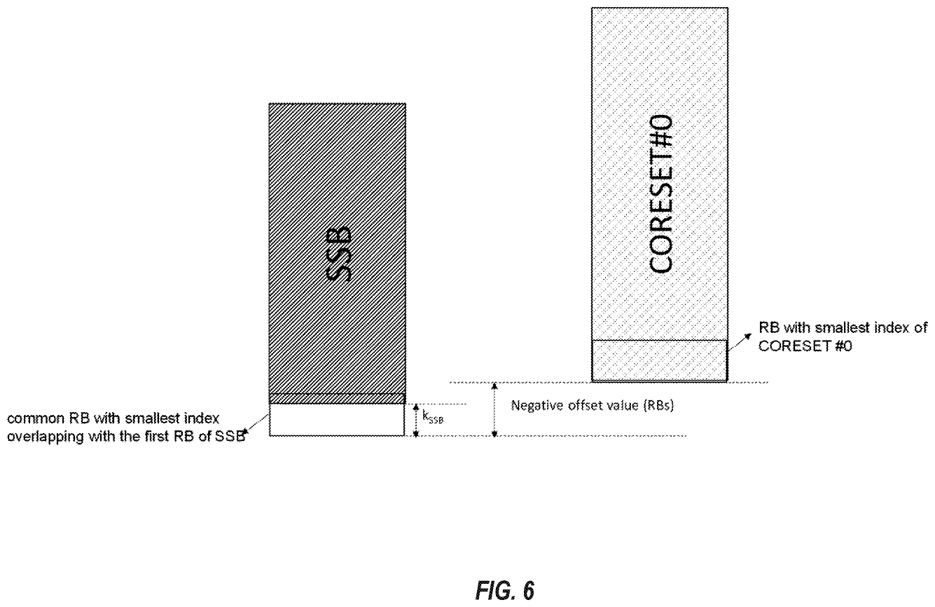

The offset values are defined as an offset in RBs from the lowest RB of CORESET #0 to the first common RB overlapping with SSB. With the negative value, it implies that the first (lowest) PRB of CORESET #0 can be positioned above the first PRB of the corresponding SSB (See FIG. 6 for an illustrating example). In some cases, the negative offset values introduced depend on the value range of the higher-layer parameter ssb-SubcarrierOffset (k_{SSB}), e.g., it should account for the largest k_{SSB} so that the first (lowest) PRB of CORESET #0 can be positioned above the first PRB of the corresponding SSB.

TABLE 4
Set of resource blocks and slot symbols of CORESET for Type0-PDCCH search space
set when {SS/PBCH block, PDCCH} SCS is {15, 15} kHz for frequency bands with minimum
channel bandwidth of less than 5 MHz. Note that the entries highlighted in bold, italicized text
are the new entries with new offset values (compared to those in Table 13-1 in TS 38.213)

| | | Number of | Number of | |
|---|---|---|---|---|
| | SS/PBCH block and | RBs | Symbols | |
| Index | CORESET multiplexing pattern | ${N}_{R B}^{C O R E S E T}$ | ${N}_{s y m b}^{CORESET}$ | Offset (RBs) |
| 0 | 1 | 24 | 2 | 0 |
| 1 | 1 | 24 | 2 | 2 |
| 2 | 1 | 24 | 2 | 4 |
| 3 | 1 | 24 | 3 | 0 |
| 4 | 1 | 24 | 3 | 2 |
| 5 | 1 | 24 | 3 | 4 |
| 6 | 1 | 24 | 2 | 1 |
| 7 | 1 | 24 | 2 | 3 |
| 8 | 1 | 24 | 2 | −2 |
| 9 | 1 | 24 | 2 | −4 |
| 10 | 1 | 24 | 3 | 1 |
| 11 | 1 | 24 | 3 | 3 |
| 12 | 1 | 24 | 3 | −2 |
| 13 | 1 | 24 | 3 | −4 |

| | |
|---|---|
| 14 | Reserved |
| 15 | Reserved |

FIG. 6 illustrates an example of when negative offset value is applied to determine CORESET #0 position with respect to the corresponding SSB. Since the offset parameter is defined as an offset in RBs from the lowest RB of CORESET #0 to the first common RB overlapping with SSB, the negative offset value results in the first (lowest) PRB of CORESET #0 being positioned above the first PRB of the corresponding SSB.

In another embodiment, instead of introducing new values in a new table, a new table for CORESET #0 configuration for NR operation with narrow channel bandwidth of less than 5 MHz consists of some duplicate entries of all column entries except index value. That is, two (or more) unique index values correspond to the same configuration settings/parameters. For example, the configuration settings/parameters of index 0-5 are duplicated in the table for index 6-10. This allows for improved detection of the CORESET #0 configuration by adding redundancy with the goal of protecting the configuration parameters of CORESET #0 in a punctured PBCH.

In the following embodiments, embodiments of solutions to consider a new reference point of the SSB to which the offset value is applied are described.

In one non-limiting embodiment, for NR operation with narrow channel bandwidth of less than 5 MHz, the offset values are interpreted as an offset in RBs from the lowest RB of CORESET #0 to the common RB overlapping with a new reference point of the corresponding SSB. The new reference point can be fixed in the specifications or configured by the network to be at a certain subcarrier index other than the lowest index of the SSB. This is different from the legacy interpretation in that the offset value is with respect to the new reference point instead of the lower edge of SSB. With the new reference point, it implies that the first (lowest) PRB of CORESET #0 can be positioned above the first PRB of the corresponding SSB even with the existing offset values.

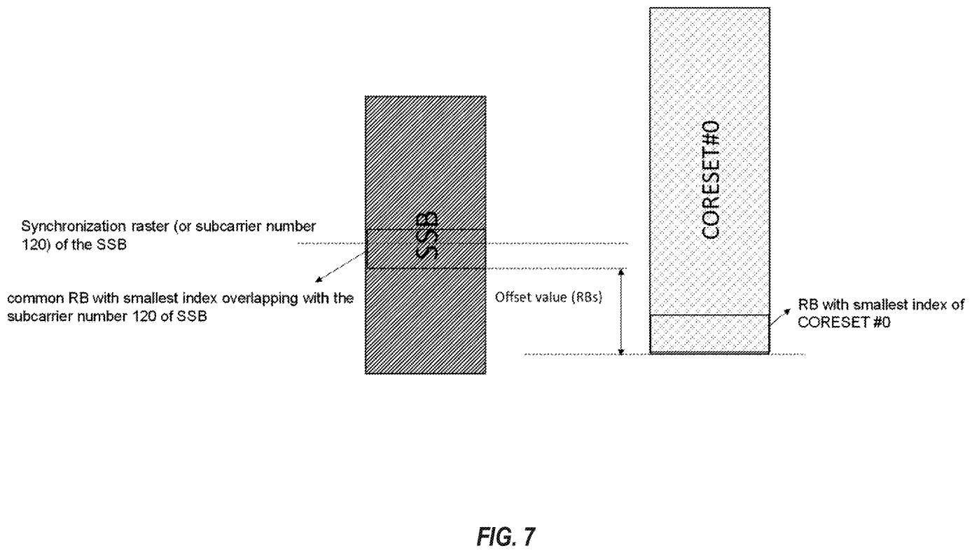

In one version of the above embodiment, the new reference point is the synchronization raster or the subcarrier number 120 of the corresponding SSB. FIG. 7 illustrates an example of when the offset value is applied with respect to a new reference point of the corresponding SSB. In this case, the offset value is defined as an offset in RBs from the lowest RB of CORESET #0 to the first common RB overlapping with the subcarrier number 120 (approx. mid-point) of SSB.

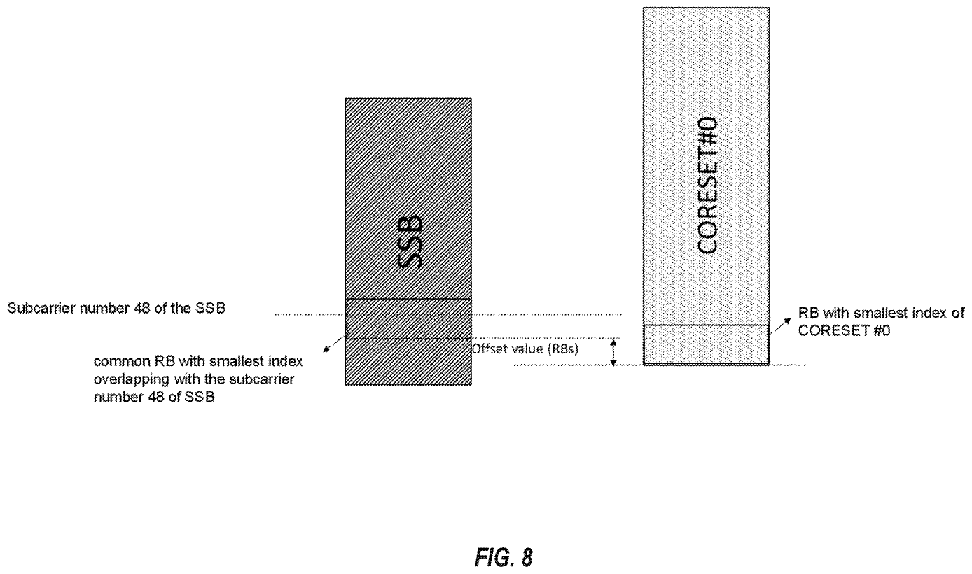

In one version of the above embodiment, the new reference point is the subcarrier number 48 of the corresponding SSB. FIG. 8 illustrates an example of when the offset value is applied with respect to a new reference point of the corresponding SSB. In this case, the offset value is defined as an offset in RBs from the lowest RB of CORESET #0 to the first common RB overlapping with the subcarrier number 48 (close to the first/lowest subcarrier of PSS/SSS) of SSB.

In a related embodiment, whether to apply the offsets in Table 3 as an offset in RBs from the lowest RB of CORESET #0 to the common RB overlapping with a new reference point of the corresponding SSB is indicated using the spare bit available in master information block carried by the SSB PBCH.

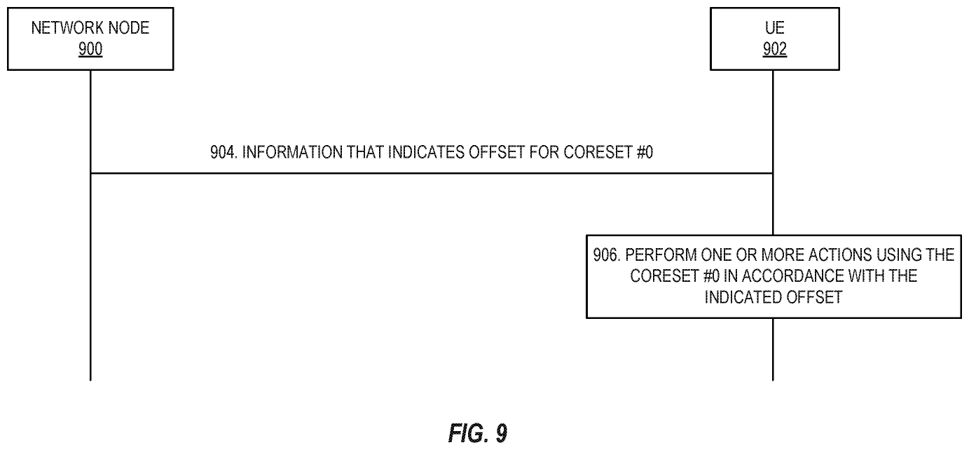

FIG. 9 illustrates the operation of a network node 900 (e.g., a base station such as, e.g., a next generation Node B (gNB) or a RAN node that implements part of the functionality of a base station such as, e.g., a gNB Central Unit (gNB-CU) or a gNB Distributed Unit (gNB-DU)) and a UE 902, in accordance with at least some of the embodiments described above. As illustrated, the network node 900 transmits, and the UE 902 receives, information that indicates an offset (e.g., in terms of the number of RBs) for CORESET #0 (step 904). In one embodiment, this information is included in the Master Information Block (MIB) broadcast by the network node 900. In one particular embodiment, the information comprises an index to a defined table that maps different index values to different sets of values for a configuration parameters for CORESET #0 (e.g., maps each index value to a corresponding set of values for SS/PBCH block and CORESET multiplexing pattern, number of RBs for the CORESET, number of symbols for the CORESET, and the offset.

As discussed above, in one embodiment, the offset is defined as the RBs from the lowest RB of CORESET #0 to the first common RB overlapping with SSB, and the indicated offset for CORESET #0 is one of a predefined set of offsets which include one or more negative values and, optionally, one or more positive values (see, e.g., Table 4). In one example, the indicated offset is a negative value. The other related embodiments are equally applicable here.

In another embodiment, the offset is defined as the RBs from the first common RB overlapping with SSB to the lowest RB of CORESET #0, and the indicated offset for CORESET #0 is one of a predefined set of offsets, which may include only one or more positive offset values (but may optionally also include one or more negative values). In one embodiment, whether to apply the indicated offset as an offset in RBs from the first common RB overlapping with SSB to the lowest RB of CORESET #0 is indicated by the network node 900, e.g., using a spare bit available in the MIB carried by the SSB PBCH.

In another embodiment, the offset is defined as an offset in RBs from the lowest RB of CORESET #0 to the common RB overlapping with a new reference point of the corresponding SSB. In one embodiment, the new reference point is the synchronization raster or the subcarrier number 120 of the corresponding SSB. In another embodiment, the new reference point is the subcarrier number 48 of the corresponding SSB. In one embodiment, whether to apply the offsets in Table 3 as an offset in RBs from the lowest RB of CORESET #0 to the common RB overlapping with a new reference point of the corresponding SSB is indicated using the spare bit available in master information block carried by the SSB PBCH.

At the UE 902, the UE 902 performs one or more operations using CORESET #0 in accordance with the indicated offset (step 906). For example, the UE 902 may perform a search procedure within CORESET #0 by performing blind decoding on one or more PDCCH candidates in CORESET #0, as will be understood by those of ordinary skill in the art.

### 3 Modified PDCCH Candidate Mapping onto CORESET #0

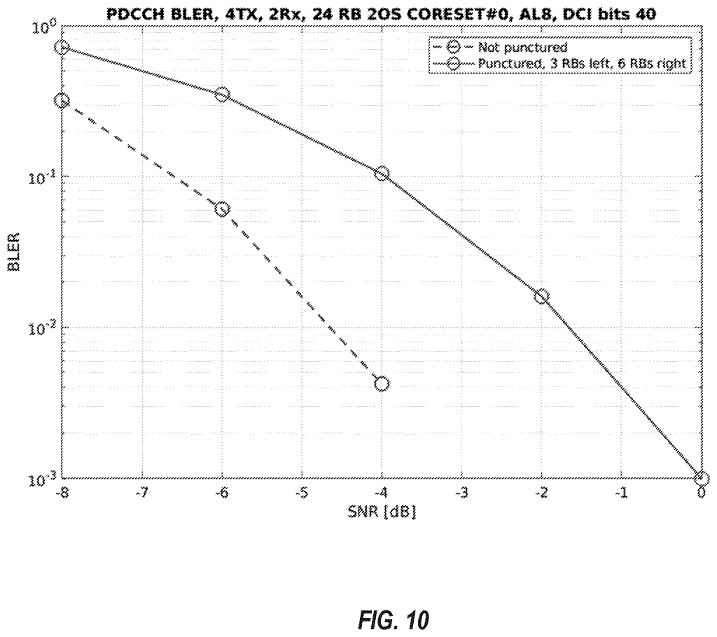

When the channel bandwidth is of smaller size than the CORESET #0 frequency domain allocation, some part of the PDCCH candidate can be affected, e.g., by PRB puncturing. Depending on the amount of PRBs being punctured, the remaining parts of the candidate may still be decodable with some performance loss compared to the full candidate (See FIG. 10 for an example illustrating performance loss of the punctured AL8 PDCCH candidate).

FIG. 10 illustrates an example of performance of PDCCH reception in terms of Block Error Rate (BLER) vs. Signal to Noise Ratio (SNR). Here, the figure shows that AL8 PDCCH candidate whose 9 PRBs are punctured is still decodable but with some performance loss, e.g., approx. 3 dB loss at the target BLER of 1% compared to the full candidate.

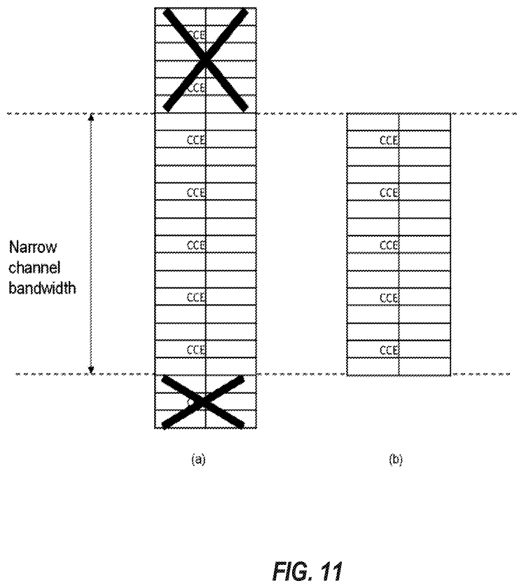

From a coding gain perspective, a punctured PDCCH candidate would result in worse performance when compared to PDCCH candidate mapped onto resources confined within the narrow channel bandwidth (i.e., without puncturing). See FIG. 11 for an illustrating example.

FIG. 11(a) illustrates the case where the PDCCH candidate with 8 CCEs is punctured due to the narrow channel bandwidth, i.e., 3 CCEs are punctured and only 5 remaining CCEs are transmitted by the base station (e.g., gNB) and received by the UE. FIG. 11(b) illustrates an alternative PDCCH candidate mapping where the candidate is mapped to the 5-CCE region which are confined within the narrow channel bandwidth without any puncturing. From the coding rate point of view, the cases of FIG. 11(a) and FIG. 11(b) are equivalent, i.e., same DCI is transmitted over the same number of resources spanning 5 CCEs and thus the same effective code rate. However, from a coding gain perspective, the punctured candidate in FIG. 11(a) results in a worse PDCCH reception performance compared to FIG. 11(b).

In one non-limiting embodiment, for NR operation with narrow channel bandwidth of less than 5 MHz, when the CORESET #0 configuration results in CORESET #0 frequency domain allocation larger than the channel bandwidth, PDCCH candidate mapping is performed with respect to a new reference frequency domain resource of CORESET #0. The new reference frequency domain resource of CORESET #0 is fully confined within the narrow channel transmission bandwidth. The channel transmission bandwidth here refers to parts of the channel bandwidth excluding guardbands.

The new reference frequency domain resource of CORESET #0 used for PDCCH candidate mapping can be determined to consist of all contiguous PRBs which are confined within the narrow channel transmission bandwidth. Further, it can be determined to consist of contiguous PRBs with total size of multiple integers of 6 PRBs which are fully confined within the narrow channel transmission bandwidth.

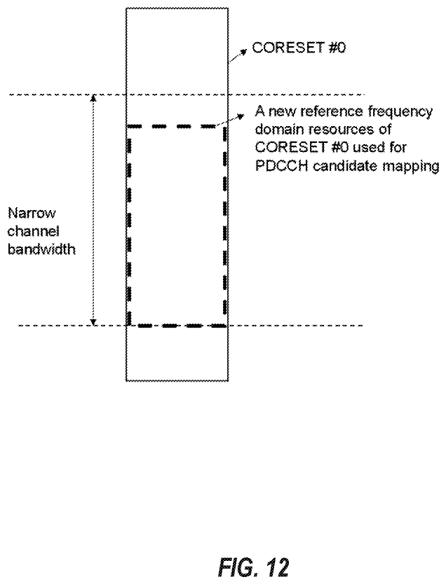

In a related embodiment, if the size of the determined new reference frequency domain resource is smaller than that of the narrow channel transmission bandwidth, the new reference frequency domain resource can be assumed to be positioned within the narrow channel bandwidth such that its lowest PRB index is aligned with the lowest PRB index of the narrow channel transmission bandwidth. See FIG. 12 for an illustration. FIG. 12 illustrates an example where the new reference frequency domain resource is of total size smaller than the narrow channel bandwidth. In this case, the new reference frequency domain resource is assumed to be positioned within the narrow channel bandwidth such that its lowest PRB index is aligned with the lowest PRB index of the narrow channel bandwidth.

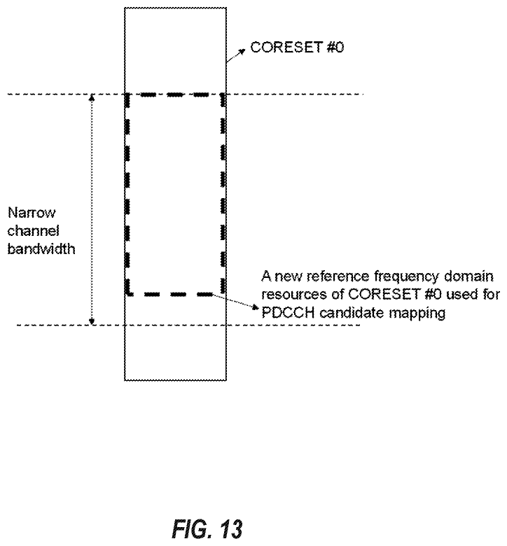

In a related alternative embodiment, if the size of the determined new reference frequency domain resource is smaller than that of the narrow channel transmission bandwidth, the new reference frequency domain resource can be assumed to be positioned within the narrow channel bandwidth such that its highest PRB index is aligned with the highest PRB index of the narrow channel transmission bandwidth. See FIG. 13 for illustration. FIG. 13 illustrates an example where the new reference frequency domain resource is of total size smaller than the narrow channel bandwidth. In this case, the new reference frequency domain resource is assumed to be positioned within the narrow channel bandwidth such that its highest PRB index is aligned with the highest PRB index of the narrow channel bandwidth.

Once the new reference frequency domain resource of CORESET #0 used for PDCCH candidate mapping is determined, the PDCCH candidate mapping follows the existing mappings defined in the specifications where the CORESET #0 size in frequency domain is replaced by the size of the new reference frequency domain resource of CORESET #0. This implies that the number of CCEs or the number of REG bundles within CORESET #0 would be replaced by the number of CCEs or the number of REG bundles within the new reference frequency domain resource of CORESET #0.

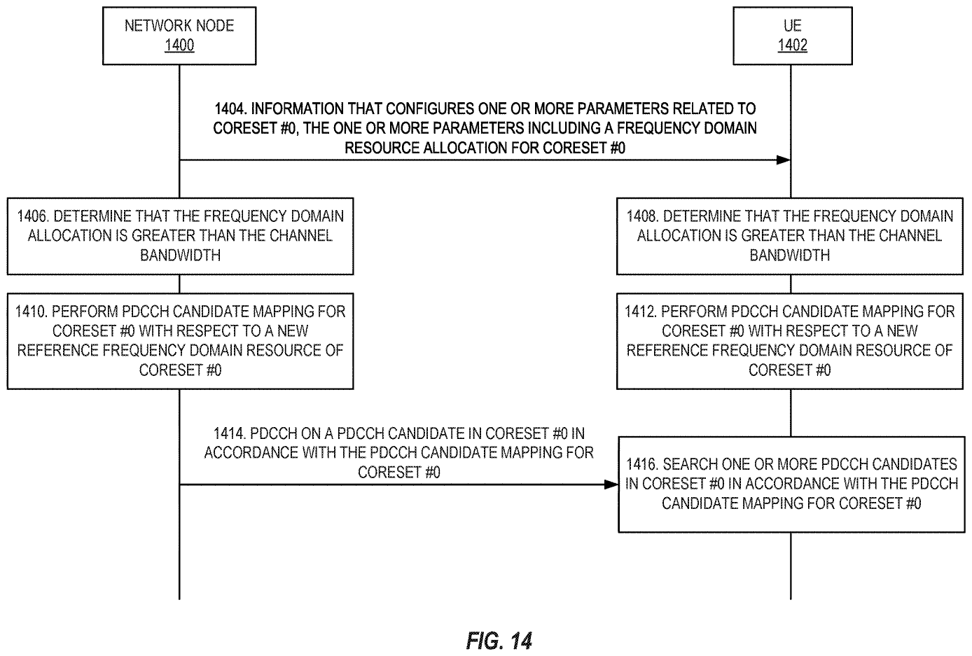

FIG. 14 illustrates the operation of a network node 1400 (e.g., a base station such as, e.g., a gNB or a RAN node that implements part of the functionality of a base station such as, e.g., a gNB-CU or a gNB-DU) and a UE 1402, in accordance with at least some of the embodiments described above. As illustrated, the network node 1400 transmits, and the UE 1402 receives, information that configures one or more parameters related to CORESET #0, where these one or more parameters include one or more parameters that indicate a frequency domain allocation for CORESET #0 (step 1404). The network node 1400 and/or the UE 1402 determine that the frequency domain allocation for CORESET #0 is greater than the channel bandwidth (steps 1406 and 1408).

In one embodiment, responsive to determining that the frequency domain allocation for CORESET #0 is greater than the channel bandwidth, the network node 1400 and the UE 1402 perform PDCCH candidate mapping for CORESET #0 with respect to a new reference frequency domain resource of CORESET #0 (steps 1410 and 1412). As described above, the new reference frequency domain resource of CORESET #0 is fully confined within the narrow channel transmission bandwidth. The channel transmission bandwidth here refers to parts of the channel bandwidth excluding guardbands. Examples of this new reference frequency domain resource of CORESET #0 are described above and are equally applicable here.

In one embodiment, if the size of the new reference frequency domain resource is smaller than that of the channel transmission bandwidth, the new reference frequency domain resource can be assumed to be positioned within the narrow channel bandwidth such that its lowest PRB index is aligned with the lowest PRB index of the narrow channel transmission bandwidth.

In one embodiment, the size of the new reference frequency domain resource is smaller than that of the channel transmission bandwidth, the new reference frequency domain resource can be assumed to be positioned within the narrow channel bandwidth such that its highest PRB index is aligned with the highest PRB index of the narrow channel transmission bandwidth.

The network node 1400 transmits a PDCCH in one of one or more PDCCH candidates comprised in CORESET #0 in accordance with the performed PDCCH candidate mapping for CORESET #0 (step 1414). The UE 1402 searches one or more PDCCH candidates in CORESET #0 in accordance with the performed PDCCH candidate mapping for CORESET #0 (step 1416).

### 4 Scheduling of Broadcast PDSCH Based on CORESET #0

Broadcast PDSCH such as PDSCH carrying System Information Block 1 (SIB1), paging and Msg 4 (i.e., Msg4 of the random access procedure) are scheduled by a Downlink Control Information (DCI) format in which the frequency domain resource assignment field is applied with respect to the size of CORESET #0.

For NR operation with narrow channel bandwidth of less than 5 MHz where the smallest CORESET #0 size of 24 RBs exceeds the narrow channel bandwidth, some scheduling restrictions are needed to prevent the broadcast PDSCH being punctured as well.

In one non-limiting embodiment, when the CORESET #0 size exceeds the narrow channel bandwidth, the scheduling of broadcast PDSCH are such that the frequency domain resource assignment field in the DCI format is applied with respect to the size of the new reference frequency domain resource of CORESET #0 for broadcast PDSCH scheduling. That is, the frequency domain resource allocation of the broadcast PDSCH are with respect to and confined within the new reference frequency domain resource of CORESET #0 for broadcast PDSCH scheduling.

The new frequency domain resource of CORESET #0 for broadcast PDSCH scheduling can be defined such that it is confined within the narrow channel bandwidth. One preferred example is that when the CORESET #0 size exceeds the narrow channel bandwidth, the new reference frequency domain resource of CORESET #0 for broadcast PDSCH scheduling is assumed to be equal to the narrow channel bandwidth defined based on the transmission bandwidth configuration (i.e., excluding necessary minimum guardbands).

Alternatively, the new reference frequency domain resource of CORESET #0 for broadcast PDSCH scheduling can be determined similarly as that used for PDCCH candidate mapping described in Section 3 above.

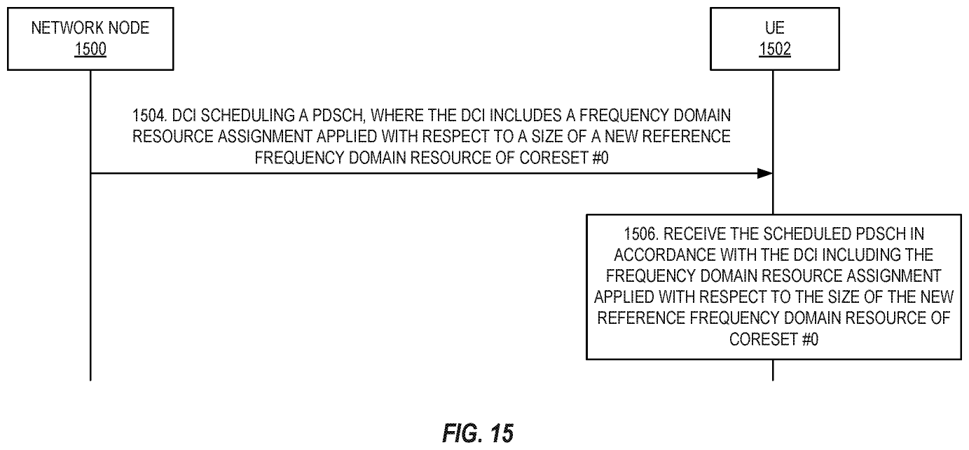

FIG. 15 illustrates the operation of a network node 1500 (e.g., a base station such as, e.g., a gNB or a RAN node that implements part of the functionality of a base station such as, e.g., a gNB-CU or a gNB-DU) and a UE 1502, in accordance with at least some of the embodiments described above. As illustrated, the network node 1500 transmits, and the UE 1502 receives, a DCI scheduling a PDSCH (e.g., a broadcast PDSCH such as PDSCH carrying SIB1, paging, and Msg 4), where the DCI includes a frequency domain resource assignment applied with respect to the size of the new reference frequency domain resource of CORESET #0 (step 1504). Here, the new reference frequency domain resource of CORESET #0 is the same as that described above, e.g., in Section 3. In one embodiment, the frequency domain resource assignment applied with respect to the size of the new reference frequency domain resource of CORESET #0 is used responsive to the network node 1500 determining that the frequency domain allocation for CORESET #0 is greater than the channel bandwidth. The UE 1502 then receives the scheduled PDSCH in accordance with the DCI including the frequency domain resource assignment applied with respect to the size of the new reference frequency domain resource of CORESET #0 (step 1506).

### 5 Relaxation of BWP Constraints Related to CORESET #0

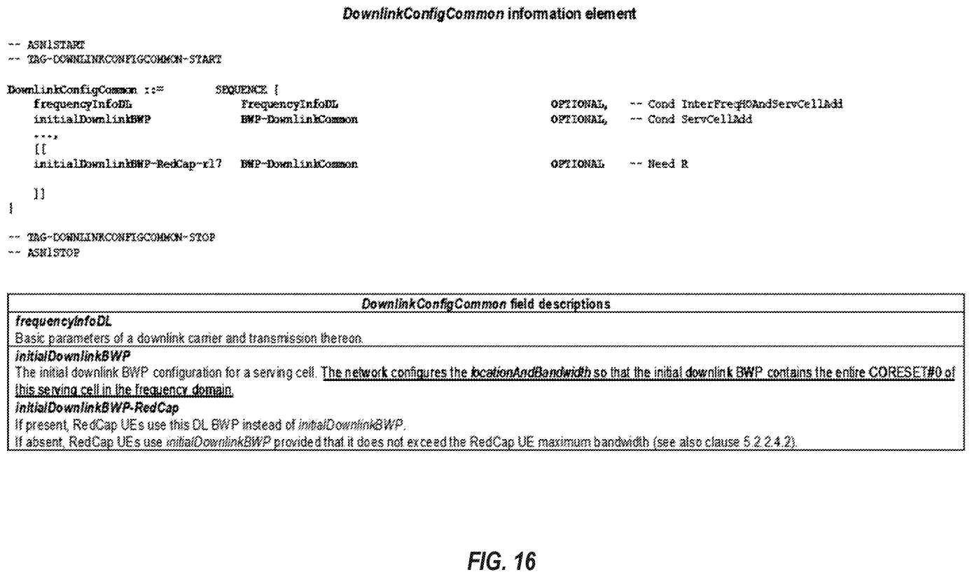

In the existing NR specifications, e.g., 3GPP TS 38.331, there exist some constraints on the configuration of initial downlink bandwidth part (BWP) that it should contain the entire CORESET #0. See FIG. 16 for the description of such constraint in 3GPP TS 38.331. In FIG. 16, the underlined sentence shows description of the restriction of initial downlink (DL) BWP configuration that should contain the entire CORESET #0.

For NR operation with narrow channel bandwidth of approximately 3 MHz to less than 5 MHz, the existing CORESET #0 configuration may span in frequency domain resources larger than the narrow channel bandwidth. Since the initial downlink BWP is expected to be configured within the narrow channel bandwidth, it implies that it may not be possible to configure the initial downlink BWP containing the entire CORESET #0 without it being punctured as well.

In one non-limiting embodiment, for NR operation with narrow channel bandwidth of approximately 3 MHz to less than 5 MHz, the initial downlink BWP may not contain the entire CORESET #0. In such case, the CORESET #0 is considered punctured. By punctured, it means that the UE is still expected to receive (punctured) PDCCH in this CORESET #0.

In an alternative embodiment, for NR operation with narrow channel bandwidth of approximately 3 MHz to less than 5 MHz, the initial downlink BWP still needs to be configured such that it contains the entire CORESET #0. In case that CORESET #0 frequency domain resource size is larger than the narrow channel bandwidth, the initial downlink BWP is allowed to be punctured. That is, the location in terms of the starting PRB and size in terms of the number of PRBs can result in parts of the initial downlink BWP being outside of the narrow channel bandwidth. Any scheduling with respect to this initial downlink BWP may span in frequency domain beyond the narrow channel bandwidth. In such case, the scheduled downlink transmission and reception will be punctured.

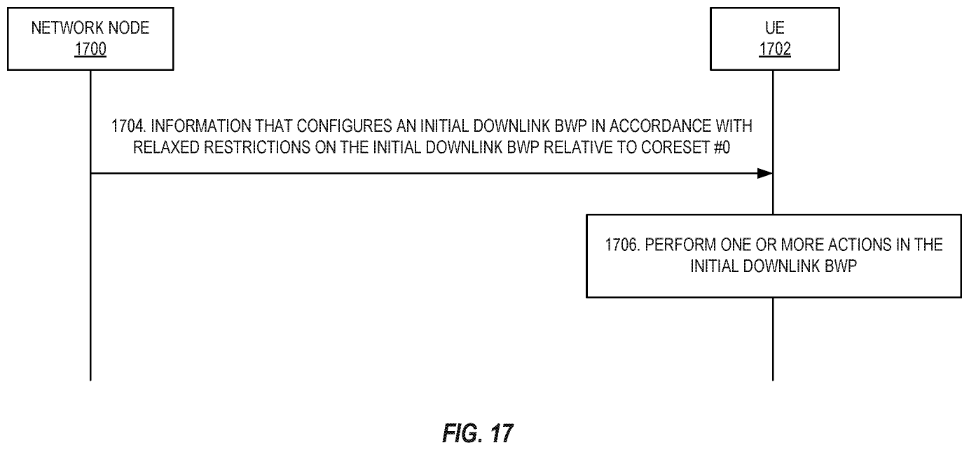

FIG. 17 illustrates the operation of a network node 1700 (e.g., a base station such as, e.g., a gNB or a RAN node that implements part of the functionality of a base station such as, e.g., a gNB-CU or a gNB-DU) and a UE 1702, in accordance with at least some of the embodiments described above. As illustrated, the network node 1700 transmits, and the UE 1702 receives, information that configures an initial downlink BWP for the UE 1702, based on one or more relaxed restrictions on the initial downlink BWP relative to CORESET #0 (step 1704).

As discussed above, in one embodiment, for NR operation with narrow channel bandwidth of approximately 3 MHz to less than 5 MHz, the relaxed restrictions are such that the initial downlink BWP may not contain the entire CORESET #0. In such case, the CORESET #0 is considered punctured. By punctured, it means that the UE 402 is still expected to receive (punctured) PDCCH in this CORESET #0.

In another embodiment, for NR operation with narrow channel bandwidth of approximately 3 MHz to less than 5 MHz, the relaxed restrictions are such that the initial downlink BWP still needs to be configured such that it contains the entire CORESET #0. However, in case that CORESET #0 frequency domain resource size is larger than the narrow channel bandwidth, the initial downlink BWP is allowed to be punctured. That is, the location in terms of the starting PRB and size in terms of the number of PRBs can result in parts of the initial downlink BWP being outside of the narrow channel bandwidth. Any scheduling with respect to this initial downlink BWP may span in frequency domain beyond the narrow channel bandwidth. In such case, the scheduled downlink transmission and reception will be punctured.

The UE 1702 then performs one or more actions using the initial downlink BWP (e.g., receives a PDCCH in CORESET #0 on the initial downlink BWP that includes DCI that schedules a PDSCH on the initial downlink BWP, and receive the scheduled receives the scheduled PDSCH in accordance with the received DCI) (step 1706).

### 6 Further Description

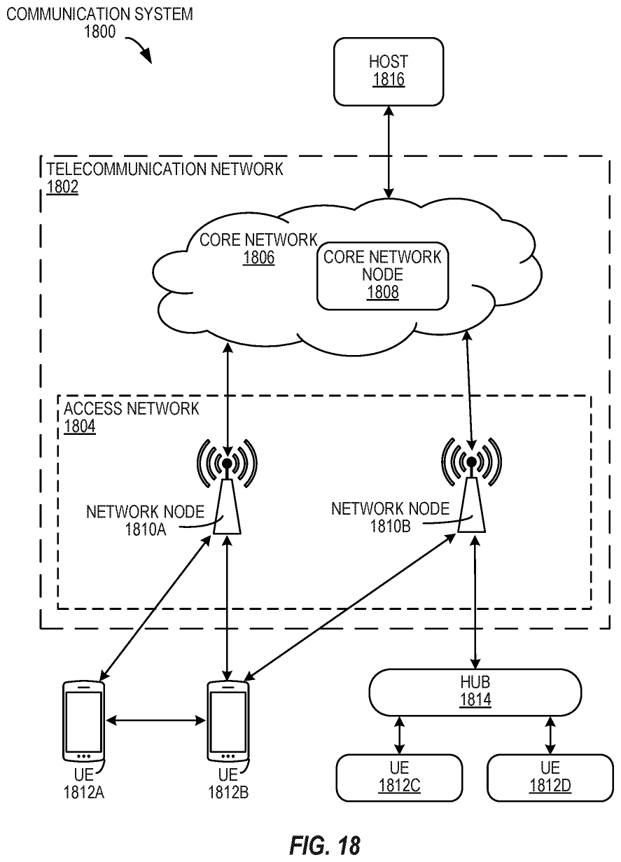

FIG. 18 shows an example of a communication system 1800 in accordance with some embodiments.

In the example, the communication system 1800 includes a telecommunication network 1802 that includes an access network 1804, such as a Radio Access Network (RAN), and a core network 1806, which includes one or more core network nodes 1808. The access network 1804 includes one or more access network nodes, such as network nodes 1810A and 1810B (one or more of which may be generally referred to as network nodes 1810), or any other similar Third Generation Partnership Project (3GPP) access node or non-3GPP Access Point (AP). The network nodes 1810 facilitate direct or indirect connection of User Equipment (UE), such as by connecting UEs 1812A, 1812B, 1812C, and 1812D (one or more of which may be generally referred to as UEs 1812) to the core network 1806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1800 may include any number of wired or wireless networks, network nodes, UEs, and/or any other components or systems that may facilitate or participate in the communication of data and/or signals whether via wired or wireless connections. The communication system 1800 may include and/or interface with any type of communication, telecommunication, data, cellular, radio network, and/or other similar type of system.

The UEs 1812 may be any of a wide variety of communication devices, including wireless devices arranged, configured, and/or operable to communicate wirelessly with the network nodes 1810 and other communication devices. Similarly, the network nodes 1810 are arranged, capable, configured, and/or operable to communicate directly or indirectly with the UEs 1812 and/or with other network nodes or equipment in the telecommunication network 1802 to enable and/or provide network access, such as wireless network access, and/or to perform other functions, such as administration in the telecommunication network 1802.

In the depicted example, the core network 1806 connects the network nodes 1810 to one or more hosts, such as host 1816. These connections may be direct or indirect via one or more intermediary networks or devices. In other examples, network nodes may be directly coupled to hosts. The core network 1806 includes one more core network nodes (e.g., core network node 1808) that are structured with hardware and software components. Features of these components may be substantially similar to those described with respect to the UEs, network nodes, and/or hosts, such that the descriptions thereof are generally applicable to the corresponding components of the core network node 1808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 1816 may be under the ownership or control of a service provider other than an operator or provider of the access network 1804 and/or the telecommunication network 1802, and may be operated by the service provider or on behalf of the service provider. The host 1816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1800 of FIG. 18 enables connectivity between the UEs, network nodes, and hosts. In that sense, the communication system 1800 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 1802 is a cellular network that implements 3GPP standardized features. Accordingly, the telecommunication network 1802 may support network slicing to provide different logical networks to different devices that are connected to the telecommunication network 1802. For example, the telecommunication network 1802 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 1812 are configured to transmit and/or receive information without direct human interaction. For instance, a UE may be designed to transmit information to the access network 1804 on a predetermined schedule, when triggered by an internal or external event, or in response to requests from the access network 1804. Additionally, a UE may be configured for operating in single- or multi-Radio Access Technology (RAT) or multi-standard mode. For example, a UE may operate with any one or combination of WiFi, New Radio (NR), and LTE, i.e. be configured for Multi-Radio Dual Connectivity (MR-DC), such as Evolved UMTS Terrestrial RAN (E-UTRAN) NR-Dual Connectivity (EN-DC).

In the example, a hub 1814 communicates with the access network 1804 to facilitate indirect communication between one or more UEs (e.g., UE 1812C and/or 1812D) and network nodes (e.g., network node 1810B). In some examples, the hub 1814 may be a controller, router, content source and analytics, or any of the other communication devices described herein regarding UEs. For example, the hub 1814 may be a broadband router enabling access to the core network 1806 for the UEs. As another example, the hub 1814 may be a controller that sends commands or instructions to one or more actuators in the UEs. Commands or instructions may be received from the UEs, network nodes 1810, or by executable code, script, process, or other instructions in the hub 1814. As another example, the hub 1814 may be a data collector that acts as temporary storage for UE data and, in some embodiments, may perform analysis or other processing of the data. As another example, the hub 1814 may be a content source. For example, for a UE that is a Virtual Reality (VR) headset, display, loudspeaker or other media delivery device, the hub 1814 may retrieve VR assets, video, audio, or other media or data related to sensory information via a network node, which the hub 1814 then provides to the UE either directly, after performing local processing, and/or after adding additional local content. In still another example, the hub 1814 acts as a proxy server or orchestrator for the UEs, in particular in if one or more of the UEs are low energy IoT devices.

The hub 1814 may have a constant/persistent or intermittent connection to the network node 1810B. The hub 1814 may also allow for a different communication scheme and/or schedule between the hub 1814 and UEs (e.g., UE 1812C and/or 1812D), and between the hub 1814 and the core network 1806. In other examples, the hub 1814 is connected to the core network 1806 and/or one or more UEs via a wired connection. Moreover, the hub 1814 may be configured to connect to a Machine-to-Machine (M2M) service provider over the access network 1804 and/or to another UE over a direct connection. In some scenarios, UEs may establish a wireless connection with the network nodes 1810 while still connected via the hub 1814 via a wired or wireless connection. In some embodiments, the hub 1814 may be a dedicated hub—that is, a hub whose primary function is to route communications to/from the UEs from/to the network node 1810B. In other embodiments, the hub 1814 may be a non-dedicated hub—that is, a device which is capable of operating to route communications between the UEs and the network node 1810B, but which is additionally capable of operating as a communication start and/or end point for certain data channels.

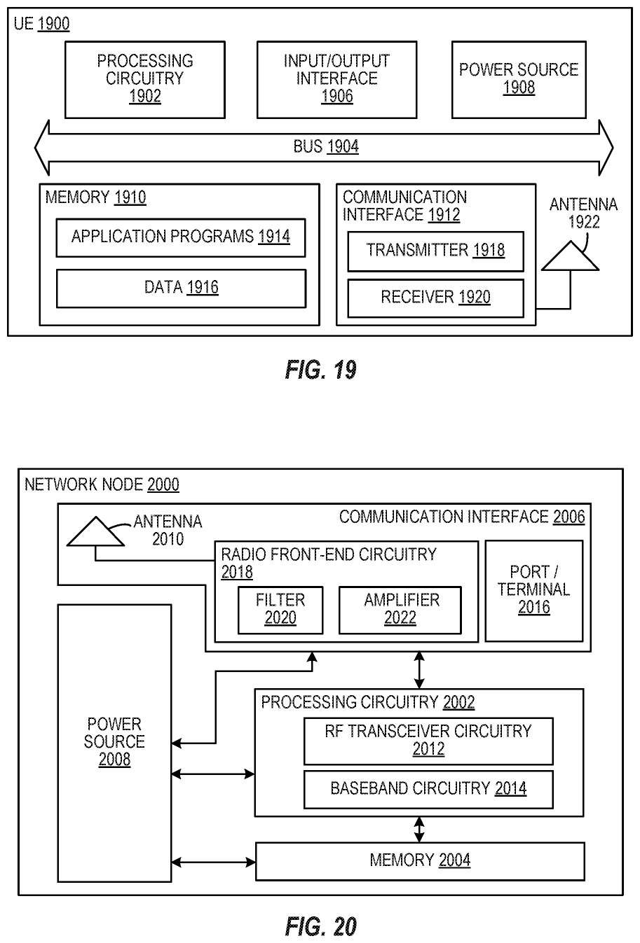

FIG. 19 shows a UE 1900 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VoIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1900 includes processing circuitry 1902 that is operatively coupled via a bus 1904 to an input/output interface 1906, a power source 1908, memory 1910, a communication interface 1912, and/or any other component, or any combination thereof. Certain UEs may utilize all or a subset of the components shown in FIG. 19. The level of integration between the components may vary from one UE to another UE. Further, certain UEs may contain multiple instances of a component, such as multiple processors, memories, transceivers, transmitters, receivers, etc.

The processing circuitry 1902 is configured to process instructions and data and may be configured to implement any sequential state machine operative to execute instructions stored as machine-readable computer programs in the memory 1910. The processing circuitry 1902 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 1902 may include multiple Central Processing Units (CPUs).

In the example, the input/output interface 1906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1908 is structured as a battery or battery pack. Other types of power sources, such as an external power source (e.g., an electricity outlet), photovoltaic device, or power cell, may be used. The power source 1908 may further include power circuitry for delivering power from the power source 1908 itself, and/or an external power source, to the various parts of the UE 1900 via input circuitry or an interface such as an electrical power cable. Delivering power may be, for example, for charging the power source 1908. Power circuitry may perform any formatting, converting, or other modification to the power from the power source 1908 to make the power suitable for the respective components of the UE 1900 to which power is supplied.

The memory 1910 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 1910 includes one or more application programs 1914, such as an operating system, web browser application, a widget, gadget engine, or other application, and corresponding data 1916. The memory 1910 may store, for use by the UE 1900, any of a variety of various operating systems or combinations of operating systems.

The memory 1910 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 1910 may allow the UE 1900 to access instructions, application programs, and the like stored on transitory or non-transitory memory media, to off-load data, or to upload data. An article of manufacture, such as one utilizing a communication system, may be tangibly embodied as or in the memory 1910, which may be or comprise a device-readable storage medium.

The processing circuitry 1902 may be configured to communicate with an access network or other network using the communication interface 1912. The communication interface 1912 may comprise one or more communication subsystems and may include or be communicatively coupled to an antenna 1922. The communication interface 1912 may include one or more transceivers used to communicate, such as by communicating with one or more remote transceivers of another device capable of wireless communication (e.g., another UE or a network node in an access network). Each transceiver may include a transmitter 1918 and/or a receiver 1920 appropriate to provide network communications (e.g., optical, electrical, frequency allocations, and so forth). Moreover, the transmitter 1918 and receiver 1920 may be coupled to one or more antennas (e.g., the antenna 1922) and may share circuit components, software, or firmware, or alternatively be implemented separately.

In the illustrated embodiment, communication functions of the communication interface 1912 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 1912, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1900 shown in FIG. 19.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 20 shows a network node 2000 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, Aps (e.g., radio Aps), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 2000 includes processing circuitry 2002, memory 2004, a communication interface 2006, and a power source 2008. The network node 2000 may be composed of multiple physically separate components (e.g., a Node B component and an RNC component, or a BTS component and a BSC component, etc.), which may each have their own respective components. In certain scenarios in which the network node 2000 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 2000 may be configured to support multiple RATs. In such embodiments, some components may be duplicated (e.g., separate memory 2004 for different RATs) and some components may be reused (e.g., an antenna 2010 may be shared by different RATs). The network node 2000 may also include multiple sets of the various illustrated components for different wireless technologies integrated into network node 2000, for example GSM, WCDMA, LTE, NR. WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 2000.

The processing circuitry 2002 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 2000 components, such as the memory 2004, to provide network node 2000 functionality.

In some embodiments, the processing circuitry 2002 includes a System on a Chip (SOC). In some embodiments, the processing circuitry 2002 includes one or more of Radio Frequency (RF) transceiver circuitry 2012 and baseband processing circuitry 2014. In some embodiments, the RF transceiver circuitry 2012 and the baseband processing circuitry 2014 may be on separate chips (or sets of chips), boards, or units, such as radio units and digital units. In alternative embodiments, part or all of the RF transceiver circuitry 2012 and the baseband processing circuitry 2014 may be on the same chip or set of chips, boards, or units.

The memory 2004 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 2002. The memory 2004 may store any suitable instructions, data, or information, including a computer program, software, an application including one or more of logic, rules, code, tables, and/or other instructions capable of being executed by the processing circuitry 2002 and utilized by the network node 2000. The memory 2004 may be used to store any calculations made by the processing circuitry 2002 and/or any data received via the communication interface 2006. In some embodiments, the processing circuitry 2002 and the memory 2004 are integrated.

The communication interface 2006 is used in wired or wireless communication of signaling and/or data between a network node, access network, and/or UE. As illustrated, the communication interface 2006 comprises port(s)/terminal(s) 2016 to send and receive data, for example to and from a network over a wired connection. The communication interface 2006 also includes radio front-end circuitry 2018 that may be coupled to, or in certain embodiments a part of, the antenna 2010. The radio front-end circuitry 2018 comprises filters 2020 and amplifiers 2022. The radio front-end circuitry 2018 may be connected to the antenna 2010 and the processing circuitry 2002. The radio front-end circuitry 2018 may be configured to condition signals communicated between the antenna 2010 and the processing circuitry 2002. The radio front-end circuitry 2018 may receive digital data that is to be sent out to other network nodes or UEs via a wireless connection. The radio front-end circuitry 2018 may convert the digital data into a radio signal having the appropriate channel and bandwidth parameters using a combination of the filters 2020 and/or the amplifiers 2022. The radio signal may then be transmitted via the antenna 2010. Similarly, when receiving data, the antenna 2010 may collect radio signals which are then converted into digital data by the radio front-end circuitry 2018. The digital data may be passed to the processing circuitry 2002. In other embodiments, the communication interface 2006 may comprise different components and/or different combinations of components.

In certain alternative embodiments, the network node 2000 does not include separate radio front-end circuitry 2018; instead, the processing circuitry 2002 includes radio front-end circuitry and is connected to the antenna 2010. Similarly, in some embodiments, all or some of the RF transceiver circuitry 2012 is part of the communication interface 2006. In still other embodiments, the communication interface 2006 includes the one or more ports or terminals 2016, the radio front-end circuitry 2018, and the RF transceiver circuitry 2012 as part of a radio unit (not shown), and the communication interface 2006 communicates with the baseband processing circuitry 2014, which is part of a digital unit (not shown).

The antenna 2010 may include one or more antennas, or antenna arrays, configured to send and/or receive wireless signals. The antenna 2010 may be coupled to the radio front-end circuitry 2018 and may be any type of antenna capable of transmitting and receiving data and/or signals wirelessly. In certain embodiments, the antenna 2010 is separate from the network node 2000 and connectable to the network node 2000 through an interface or port.

The antenna 2010, the communication interface 2006, and/or the processing circuitry 2002 may be configured to perform any receiving operations and/or certain obtaining operations described herein as being performed by the network node 2000. Any information, data, and/or signals may be received from a UE, another network node, and/or any other network equipment. Similarly, the antenna 2010, the communication interface 2006, and/or the processing circuitry 2002 may be configured to perform any transmitting operations described herein as being performed by the network node 2000. Any information, data, and/or signals may be transmitted to a UE, another network node, and/or any other network equipment.

The power source 2008 provides power to the various components of the network node 2000 in a form suitable for the respective components (e.g., at a voltage and current level needed for each respective component). The power source 2008 may further comprise, or be coupled to, power management circuitry to supply the components of the network node 2000 with power for performing the functionality described herein. For example, the network node 2000 may be connectable to an external power source (e.g., the power grid or an electricity outlet) via input circuitry or an interface such as an electrical cable, whereby the external power source supplies power to power circuitry of the power source 2008. As a further example, the power source 2008 may comprise a source of power in the form of a battery or battery pack which is connected to, or integrated in, power circuitry. The battery may provide backup power should the external power source fail.

Embodiments of the network node 2000 may include additional components beyond those shown in FIG. 20 for providing certain aspects of the network node's functionality, including any of the functionality described herein and/or any functionality necessary to support the subject matter described herein. For example, the network node 2000 may include user interface equipment to allow input of information into the network node 2000 and to allow output of information from the network node 2000. This may allow a user to perform diagnostic, maintenance, repair, and other administrative functions for the network node 2000.

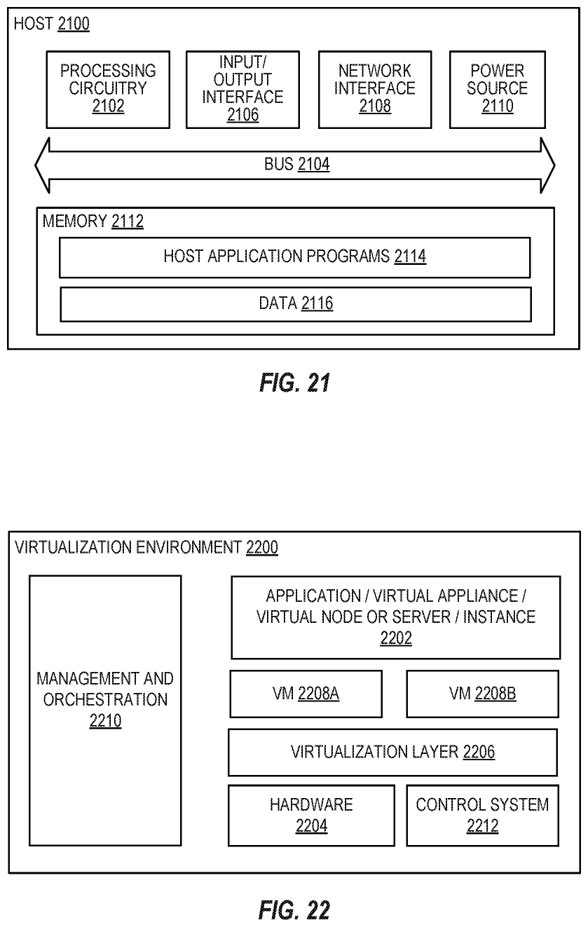

FIG. 21 is a block diagram of a host 2100, which may be an embodiment of the host 1816 of FIG. 18, in accordance with various aspects described herein. As used herein, the host 2100 may be or comprise various combinations of hardware and/or software including a standalone server, a blade server, a cloud-implemented server, a distributed server, a virtual machine, container, or processing resources in a server farm. The host 2100 may provide one or more services to one or more UEs.

The host 2100 includes processing circuitry 2102 that is operatively coupled via a bus 2104 to an input/output interface 2106, a network interface 2108, a power source 2110, and memory 2112. Other components may be included in other embodiments. Features of these components may be substantially similar to those described with respect to the devices of previous figures, such as FIGS. 19 and 20, such that the descriptions thereof are generally applicable to the corresponding components of the host 2100.

The memory 2112 may include one or more computer programs including one or more host application programs 2114 and data 2116, which may include user data, e.g. data generated by a UE for the host 2100 or data generated by the host 2100 for a UE. Embodiments of the host 2100 may utilize only a subset or all of the components shown. The host application programs 2114 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 2114 may also provide for user authentication and licensing checks and may periodically report health, routes, and content availability to a central node, such as a device in or on the edge of a core network. Accordingly, the host 2100 may select and/or indicate a different host for Over-The-Top (OTT) services for a UE. The host application programs 2114 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 22 is a block diagram illustrating a virtualization environment 2200 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 2200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2202 (which may alternatively be called software instances, virtual appliances, network functions, virtual nodes, virtual network functions, etc.) are run in the virtualization environment 2100 to implement some of the features, functions, and/or benefits of some of the embodiments disclosed herein.

Hardware 2204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2206 (also referred to as hypervisors or VM Monitors (VMMs)), provide VMs 2208A and 2208B (one or more of which may be generally referred to as VMs 2208), and/or perform any of the functions, features, and/or benefits described in relation with some embodiments described herein. The virtualization layer 2206 may present a virtual operating platform that appears like networking hardware to the VMs 2208.

The VMs 2208 comprise virtual processing, virtual memory, virtual networking, or interface and virtual storage, and may be run by a corresponding virtualization layer 2206. Different embodiments of the instance of a virtual appliance 2202 may be implemented on one or more of the VMs 2208, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 2208 may be a software implementation of a physical machine that runs programs as if they were executing on a physical, non-virtualized machine. Each of the VMs 2208, and that part of the hardware 2204 that executes that VM, be it hardware dedicated to that VM and/or hardware shared by that VM with others of the VMs 2208, forms separate virtual network elements. Still in the context of NFV, a virtual network function is responsible for handling specific network functions that run in one or more VMs 2208 on top of the hardware 2204 and corresponds to the application 2202.

The hardware 2204 may be implemented in a standalone network node with generic or specific components. The hardware 2204 may implement some functions via virtualization. Alternatively, the hardware 2204 may be part of a larger cluster of hardware (e.g., such as in a data center or CPE) where many hardware nodes work together and are managed via management and orchestration 2210, which, among others, oversees lifecycle management of the applications 2202. In some embodiments, the hardware 2204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 2212 which may alternatively be used for communication between hardware nodes and radio units.

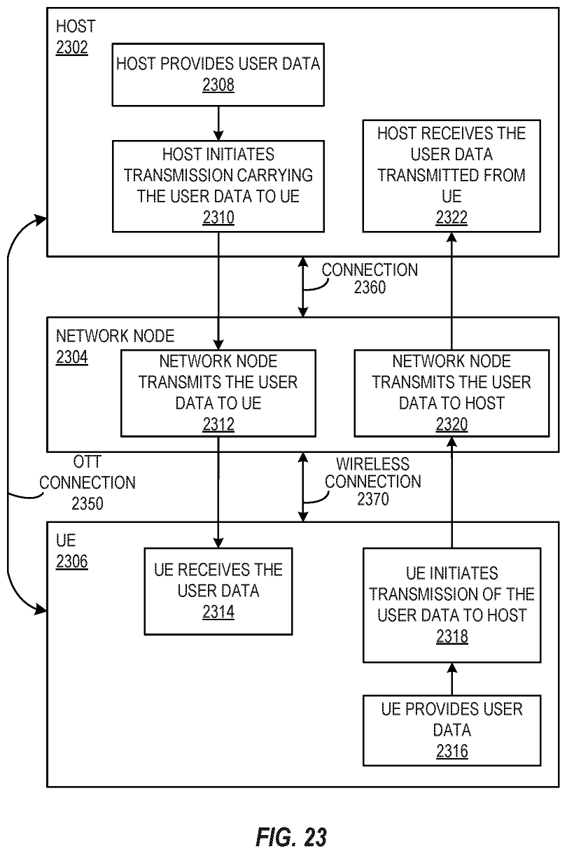

FIG. 23 shows a communication diagram of a host 2302 communicating via a network node 2304 with a UE 2306 over a partially wireless connection in accordance with some embodiments. Example implementations, in accordance with various embodiments, of the UE (such as the UE 1812A of FIG. 18 and/or the UE 1900 of FIG. 19), the network node (such as the network node 1810A of FIG. 18 and/or the network node 2000 of FIG. 20), and the host (such as the host 1816 of FIG. 18 and/or the host 2100 of FIG. 21) discussed in the preceding paragraphs will now be described with reference to FIG. 23.

Like the host 2100, embodiments of the host 2302 include hardware, such as a communication interface, processing circuitry, and memory. The host 2302 also includes software, which is stored in or is accessible by the host 2302 and executable by the processing circuitry. The software includes a host application that may be operable to provide a service to a remote user, such as the UE 2306 connecting via an OTT connection 2350 extending between the UE 2306 and the host 2302. In providing the service to the remote user, a host application may provide user data which is transmitted using the OTT connection 2350.

The network node 2304 includes hardware enabling it to communicate with the host 2302 and the UE 2306 via a connection 2360. The connection 2360 may be direct or pass through a core network (like the core network 1806 of FIG. 18) and/or one or more other intermediate networks, such as one or more public, private, or hosted networks. For example, an intermediate network may be a backbone network or the Internet.

The UE 2306 includes hardware and software, which is stored in or accessible by the UE 2306 and executable by the UE's processing circuitry. The software includes a client application, such as a web browser or operator-specific “app” that may be operable to provide a service to a human or non-human user via the UE 2306 with the support of the host 2302. In the host 2302, an executing host application may communicate with the executing client application via the OTT connection 2350 terminating at the UE 2306 and the host 2302. In providing the service to the user, the UE's client application may receive request data from the host's host application and provide user data in response to the request data. The OTT connection 2350 may transfer both the request data and the user data. The UE's client application may interact with the user to generate the user data that it provides to the host application through the OTT connection 2350.

The OTT connection 2350 may extend via the connection 2360 between the host 2302 and the network node 2304 and via a wireless connection 2370 between the network node 2304 and the UE 2306 to provide the connection between the host 2302 and the UE 2306. The connection 2360 and the wireless connection 2370, over which the OTT connection 2350 may be provided, have been drawn abstractly to illustrate the communication between the host 2302 and the UE 2306 via the network node 2304, without explicit reference to any intermediary devices and the precise routing of messages via these devices.

As an example of transmitting data via the OTT connection 2350, in step 2308, the host 2302 provides user data, which may be performed by executing a host application. In some embodiments, the user data is associated with a particular human user interacting with the UE 2306. In other embodiments, the user data is associated with a UE 2306 that shares data with the host 2302 without explicit human interaction. In step 2310, the host 2302 initiates a transmission carrying the user data towards the UE 2306. The host 2302 may initiate the transmission responsive to a request transmitted by the UE 2306. The request may be caused by human interaction with the UE 2306 or by operation of the client application executing on the UE 2306. The transmission may pass via the network node 2304 in accordance with the teachings of the embodiments described throughout this disclosure. Accordingly, in step 2312, the network node 2304 transmits to the UE 2306 the user data that was carried in the transmission that the host 2302 initiated, in accordance with the teachings of the embodiments described throughout this disclosure. In step 2314, the UE 2306 receives the user data carried in the transmission, which may be performed by a client application executed on the UE 2306 associated with the host application executed by the host 2302.

In some examples, the UE 2306 executes a client application which provides user data to the host 2302. The user data may be provided in reaction or response to the data received from the host 2302. Accordingly, in step 2316, the UE 2306 may provide user data, which may be performed by executing the client application. In providing the user data, the client application may further consider user input received from the user via an input/output interface of the UE 2306. Regardless of the specific manner in which the user data was provided, the UE 2306 initiates, in step 2318, transmission of the user data towards the host 2302 via the network node 2304. In step 2320, in accordance with the teachings of the embodiments described throughout this disclosure, the network node 2304 receives user data from the UE 2306 and initiates transmission of the received user data towards the host 2302. In step 2322, the host 2302 receives the user data carried in the transmission initiated by the UE 2306.

One or more of the various embodiments improve the performance of OTT services provided to the UE 2306 using the OTT connection 2350, in which the wireless connection 2370 forms the last segment.

In an example scenario, factory status information may be collected and analyzed by the host 2302. As another example, the host 2302 may process audio and video data which may have been retrieved from a UE for use in creating maps. As another example, the host 2302 may collect and analyze real-time data to assist in controlling vehicle congestion (e.g., controlling traffic lights). As another example, the host 2302 may store surveillance video uploaded by a UE. As another example, the host 2302 may store or control access to media content such as video, audio, VR, or AR which it can broadcast, multicast, or unicast to UEs. As other examples, the host 2302 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 2350 between the host 2302 and the UE 2306 in response to variations in the measurement results. The measurement procedure and/or the network functionality for reconfiguring the OTT connection 2350 may be implemented in software and hardware of the host 2302 and/or the UE 2306. In some embodiments, sensors (not shown) may be deployed in or in association with other devices through which the OTT connection 2350 passes; the sensors may participate in the measurement procedure by supplying values of the monitored quantities exemplified above, or by supplying values of other physical quantities from which software may compute or estimate the monitored quantities. The reconfiguring of the OTT connection 2350 may include message format, retransmission settings, preferred routing, etc.; the reconfiguring need not directly alter the operation of the network node 2304. Such procedures and functionalities may be known and practiced in the art. In certain embodiments, measurements may involve proprietary UE signaling that facilitates measurements of throughput, propagation times, latency, and the like by the host 2302. The measurements may be implemented in that software causes messages to be transmitted, in particular empty or ‘dummy’ messages, using the OTT connection 2350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Some example embodiments of the present disclosure are as follows:

### GROUP A EMBODIMENTS

Embodiment 1: A method performed by a User Equipment, UE, the method comprising one or more of the following:
Operating in a wireless spectrum allocation (e.g., an NR spectrum allocation) that is smaller than frequency domain resources needed for receiving a Synchronization Signal Block, SS,/Physical Broadcast Channel, PBCH, block and Control Resource Set, CORESET, #0;
as a result of operating in the wireless spectrum allocation that is smaller than frequency domain resources needed for receiving, from a network node, an SS/PBCH block and CORESET #0, receiving SS/PBCH block and CORESET #0 after being punctured at the network node;
decoding a message based on the punctured PBCH or PDCCH mapped to the CORESET #0, wherein decoding the message comprises:
   performing insertion of zero-valued soft-bits at bit positions corresponding to the puncturing of PBCH or PDCCH in CORESET #0.

Embodiment 2: The method of embodiment 1 wherein:
the puncturing of the SS/PBCH block is given by the following:
   a number of RBs comprised in the wireless spectrum allocation, where a location of the RBs within a respective frequency band (e.g., NR band) determines a set of candidate SSBs to consider depending on a location of a respective synchronization raster, wherein among the candidate SSBs only one or more of the candidate SSBs that preserve PSS and SSS unpunctured are selected as an ultimate selection of candidate SSB(s);
   while PSS/SSS is fully preserved, PBCH is partially preserved, wherein how much of PBCH is preserved outside the PSS/SSS region depends on the ultimate selection of the candidate SSB(s);
the puncturing on PDCCH which is mapped to CORESET #0 is determined by the puncturing applied on the SSB and one or more offset parameters (e.g., as indicated by a higher-layer parameter (e.g., ssb-SubcarrierOffset (kSSB)) and “Offset (RBs)” in a configuration of the CORESET #0).

Embodiment 3: The method of embodiment 1 or 2 further comprising:
receiving (904), from a network node (900), information that indicates an offset for CORESET #0, wherein either:
   the offset is defined as a number of resource blocks, RBs, from a lowest RB of the CORESET #0 to a first common RB overlapping with a Synchronization Signal Block, SSB, and the indicated offset for CORESET #0 is one of a predefined set of offsets that comprises one or more negative values; or
   the offset is defined as a number of RBs from the first common RB overlapping with SSB to the lowest RB of the CORESET #0, and the indicated offset for the CORESET #0 is one of a predefined set of offsets comprising only one or more positive offset values; or
   the offset is defined as number of RBs from the lowest RB of the CORESET #0 to a common RB overlapping with a new reference point of the SSB; and

Embodiment 4: The method of embodiment 3 further comprising performing (904) one or more actions using the CORESET #0 in accordance with the indicated offset.

Embodiment 5: The method of embodiment 4 wherein performing (904) the one or more actions comprises the decoding a message based on the punctured PBCH or PDCCH mapped to the CORESET #0.

Embodiment 6: The method of any of embodiments 3 to 5 wherein the offset is defined as a number of RBs from the lowest RB of the CORESET #0 to the first common RB overlapping with the SSB, and the indicated offset for CORESET #0 is one of a predefined set of offsets that comprises one or more negative values.

Embodiment 7: The method of embodiment 6 wherein the first common RB overlapping with the SSB is a common RB overlapping with SSB having a smallest RB index.

Embodiment 8: The method of embodiment 7 wherein the first common RB overlapping with the SSB is not necessarily the same as a first RB of the SSB.

Embodiment 9: The method of any of embodiments 6 to 8 wherein a location of the first common RB overlapping with the SSB is defined by a higher-layer parameter (e.g., ssb-SubcarrierOffset (k_{SSB})) which is the subcarrier offset from subcarrier 0 of the first common RB to subcarrier 0 of the SSB.

Embodiment 10: The method of any of embodiments 6 to 9 wherein the predefined set of offsets further comprises one or more positive values.

Embodiment 11: The method of any of embodiments 6 to 10 wherein the predefined set of offsets is defined in a defined table for operation (e.g., NR operation) with a channel bandwidth of less than 5 MHz.

Embodiment 12: The method of any of embodiments 6 to 10 wherein the predefined set of offsets is defined in a defined table that comprises one or more positive offset values and the one or more negative offset values.

Embodiment 13: The method of any of embodiments 6 to 10 wherein the predefined set of offsets is defined in a defined table in which one or more previously unused entries in the defined table are used to define the one or more negative offset values.

Embodiment 14: The method of embodiment 3 wherein the offset is defined as a number of RBs from the first common RB overlapping with SSB to the lowest RB of the CORESET #0, and the indicated offset for the CORESET #0 is one of a predefined set of offsets comprising only one or more positive offset values.

Embodiment 15: The method of embodiment 14 wherein the first common RB overlapping with the SSB is a common RB overlapping with SSB having a smallest RB index.

Embodiment 16: The method of embodiment 15 wherein the first common RB overlapping with the SSB is not necessarily the same as a first RB of the SSB.

Embodiment 17: The method of any of embodiments 14 to 16 wherein a location of the first common RB overlapping with the SSB is defined by a higher-layer parameter (e.g., ssb-SubcarrierOffset (k_{SSB})) which is the subcarrier offset from subcarrier 0 of the first common RB to subcarrier 0 of the SSB.

Embodiment 18: The method of any of embodiments 14 to 17 wherein whether the offset is defined as a number of RBs from the first common RB overlapping with SSB to the lowest RB of the CORESET #0 or defined as a number of RBs from the lowest RB of the CORESET #0 to the first common RB overlapping with the SSB and the indicated offset for CORESET #0 is configurable or indicated (e.g., by the network node 900, e.g., in MIB).

Embodiment 19: The method of embodiment 3 wherein the offset is defined as number of RBs from the lowest RB of the CORESET #0 to a common RB overlapping with a new reference point of the SSB.

Embodiment 20: The method of embodiment 19 wherein the new reference point is a certain subcarrier index other than a lowest index of the SSB.

Embodiment 21: The method of embodiment 19 or 20 wherein the new reference point is either fixed or configurable (e.g., by the network node 900).

Embodiment 22: The method of embodiment 19 wherein the new reference point is a synchronization raster or a subcarrier number #120 of the corresponding SSB.

Embodiment 23: The method of embodiment 19 wherein the new reference point is a subcarrier number #48 of the corresponding SSB.

Embodiment 24: The method of any of embodiments 1 to 23 wherein a channel bandwidth of a wireless channel in which the CORESET #0 is transmitted is less than 5 MHz.

Embodiment 25: The method of any of embodiments 1 to 23 wherein a channel bandwidth of a wireless channel in which the CORESET #0 is transmitted is greater than or equal to 3 MHz and less than 5 MHz.

Embodiment 26: The method of embodiment 1 further comprising one or more of the following:
receiving (1404), from a network node (1400), information that configures one or more parameters related to CORESET #0, the one or more parameters comprising a frequency domain resource allocation for CORESET #0;
determining (1408) that the frequency domain resource allocation for CORESET #0 is greater than a respective channel bandwidth;
responsive to determining (1408) that the frequency domain resource allocation for CORESET #0 is greater than the respective channel bandwidth, performing (1412) PDCCH candidate mapping for CORESET #0 with respect to a new reference frequency domain resource of CORESET #0;
searching (1416) one or more PDCCH candidates within CORESET #0 in accordance with the PDCCH candidate mapping for CORESET #0 with respect to the new reference frequency domain resource of CORESET #0.

Embodiment 27: The method of embodiment 26 wherein the new reference frequency domain resource of CORESET #0 is a reference frequency domain resource of CORESET #0 that is different than a reference frequency domain resource of CORESET #0 used for PDCCH candidate mapping if the frequency domain resource allocation for CORESET #0 is not greater than the respective channel bandwidth.

Embodiment 28: The method of embodiment 26 wherein the new reference frequency domain resource of CORESET #0 is fully contained within the respective channel bandwidth.

Embodiment 29: The method of embodiment 26 or 28 wherein the new reference frequency domain resource of CORESET #0 consists of all contiguous PRBs that are confined within the respective channel bandwidth.

Embodiment 30: The method of embodiment 26 wherein a size of the new reference frequency domain resource is smaller than that of the respective channel bandwidth, and the new reference frequency domain resource is positioned within the respective channel bandwidth such that its lowest PRB index is aligned with a lowest PRB index of the respective channel bandwidth.

Embodiment 31: The method of embodiment 26 wherein a size of the new reference frequency domain resource is smaller than that of the respective channel bandwidth, and the new reference frequency domain resource is positioned within the respective channel bandwidth such that its highest PRB index is aligned with a highest PRB index of the respective channel bandwidth.

Embodiment 32: The method of embodiment 1 further comprising one or more of the following:
receiving (1504), from a network node (1500), downlink control information, DCI, that schedules a PDSCH, wherein the DCI comprises a frequency domain resource assignment applied with respect to a size of a new reference frequency domain resource of CORESET #0; and
receiving (1506) the scheduled PDSCH in accordance with the DCI.

Embodiment 33: The method of embodiment 32 wherein the new reference frequency domain resource of CORESET #0 is a reference frequency domain resource of CORESET #0 that is different than a reference frequency domain resource of CORESET #0 used for PDCCH candidate mapping if the frequency domain resource allocation for CORESET #0 is not greater than the respective channel bandwidth.

Embodiment 34: The method of embodiment 32 wherein the new reference frequency domain resource of CORESET #0 is fully contained within the respective channel bandwidth.

Embodiment 35: The method of embodiment 32 or 34 wherein the new reference frequency domain resource of CORESET #0 consists of all contiguous PRBs that are confined within the respective channel bandwidth.

Embodiment 36: The method of embodiment 32 wherein a size of the new reference frequency domain resource is smaller than that of the respective channel bandwidth, and the new reference frequency domain resource is positioned within the respective channel bandwidth such that its lowest PRB index is aligned with a lowest PRB index of the respective channel bandwidth.

Embodiment 37: The method of embodiment 32 wherein a size of the new reference frequency domain resource is smaller than that of the respective channel bandwidth, and the new reference frequency domain resource is positioned within the respective channel bandwidth such that its highest PRB index is aligned with a highest PRB index of the respective channel bandwidth.

Embodiment 38: The method of embodiment 1 further comprising one or more of the following:
receiving (1704), from a network node (1700), information that configures an initial downlink BWP in accordance with one or more relaxed restrictions on the initial downlink BWP relative to CORESET #0; and
performing (1706) one or more actions using the initial downlink BWP.

Embodiment 39: The method of embodiment 38 wherein, for NR operation with narrow channel bandwidth of approximately 3 MHz to less than 5 MHz, the relaxed restrictions are such that the initial downlink BWP may not contain the entire CORESET #0.

Embodiment 40: The method of embodiment 38 wherein, for NR operation with narrow channel bandwidth of approximately 3 MHz to less than 5 MHz, the relaxed restrictions are such that the initial downlink BWP still needs to be configured such that it contains the entire CORESET #0.

Embodiment 41: The method of any of the previous embodiments, further comprising: providing user data; and forwarding the user data to a host via the transmission to the network node.

### GROUP B EMBODIMENTS

Embodiment 42: A method performed by a network node, the method comprising one or more of the following:
serving a User Equipment, UE, in a wireless spectrum allocation (e.g., an NR spectrum allocation) that is smaller than frequency domain resources needed for reception by the UE of a Synchronization Signal, SS,/Physical Broadcast Channel, PBCH, block and Control Resource Set, CORESET, #0;
as a result the UE operating in the wireless spectrum allocation that is smaller than frequency domain resources needed for receiving, from a network node, an SS/PBCH block and CORESET #0, transmitting SS/PBCH block and CORESET #0 after being punctured.

Embodiment 43: The method of embodiment 42 wherein:
the puncturing of the SS/PBCH block is given by the following:
   a number of RBs comprised in the wireless spectrum allocation, where a location of the RBs within a respective frequency band (e.g., NR band) determines a set of candidate SSBs to consider depending on a location of a respective synchronization raster, wherein among the candidate SSBs only one or more of the candidate SSBs that preserve PSS and SSS unpunctured are selected as an ultimate selection of candidate SSB(s);
   while PSS/SSS is fully preserved, PBCH is partially preserved, wherein how much of PBCH is preserved outside the PSS/SSS region depends on the ultimate selection of the candidate SSB(s);
the puncturing on PDCCH which is mapped to CORESET #0 is determined by the puncturing applied on the SSB and one or more offset parameters (e.g., as indicated by a higher-layer parameter (e.g., ssb-SubcarrierOffset (kSSB)) and “Offset (RBs)” in a configuration of the CORESET #0).

Embodiment 44: The method of embodiment 42 or 43 further comprising:
transmitting (904), for reception by one or more User Equipments, UEs, (900), information that indicates an offset for CORESET #0, wherein either:
   the offset is defined as a number of resource blocks, RBs, from a lowest RB of the CORESET #0 to a first common RB overlapping with a Synchronization Signal Block, SSB, and the indicated offset for CORESET #0 is one of a predefined set of offsets that comprises one or more negative values; or
   the offset is defined as a number of RBs from the first common RB overlapping with SSB to the lowest RB of the CORESET #0, and the indicated offset for the CORESET #0 is one of a predefined set of offsets comprising only one or more positive offset values; or
   the offset is defined as number of RBs from the lowest RB of the CORESET #0 to a common RB overlapping with a new reference point of the SSB.

Embodiment 45: The method of embodiment 44 wherein the offset is defined as a number of RBs from the lowest RB of the CORESET #0 to the first common RB overlapping with the SSB, and the indicated offset for CORESET #0 is one of a predefined set of offsets that comprises one or more negative values.

Embodiment 46: The method of embodiment 45 wherein the first common RB overlapping with the SSB is a common RB overlapping with SSB having a smallest RB index.

Embodiment 47: The method of embodiment 46 wherein the first common RB overlapping with the SSB is not necessarily the same as a first RB of the SSB.

Embodiment 48: The method of any of embodiments 45 to 47 wherein a location of the first common RB overlapping with the SSB is defined by a higher-layer parameter (e.g., ssb-SubcarrierOffset (k_{SSB})) which is the subcarrier offset from subcarrier 0 of the first common RB to subcarrier 0 of the SSB.

Embodiment 49: The method of any of embodiments 45 to 48 wherein the predefined set of offsets further comprises one or more positive values.

Embodiment 50: The method of any of embodiments 45 to 49 wherein the predefined set of offsets is defined in a defined table for operation (e.g., NR operation) with a channel bandwidth of less than 5 MHz.

Embodiment 51: The method of any of embodiments 45 to 49 wherein the predefined set of offsets is defined in a defined table that comprises one or more positive offset values and the one or more negative offset values.

Embodiment 52: The method of any of embodiments 45 to 49 wherein the predefined set of offsets is defined in a defined table in which one or more previously unused entries in the defined table are used to define the one or more negative offset values.

Embodiment 53: The method of embodiment 44 wherein the offset is defined as a number of RBs from the first common RB overlapping with SSB to the lowest RB of the CORESET #0, and the indicated offset for the CORESET #0 is one of a predefined set of offsets comprising only one or more positive offset values.

Embodiment 54: The method of embodiment 53 wherein the first common RB overlapping with the SSB is a common RB overlapping with SSB having a smallest RB index.

Embodiment 55: The method of embodiment 54 wherein the first common RB overlapping with the SSB is not necessarily the same as a first RB of the SSB.

Embodiment 56: The method of any of embodiments 53 to 55 wherein a location of the first common RB overlapping with the SSB is defined by a higher-layer parameter (e.g., ssb-SubcarrierOffset (k_{SSB})) which is the subcarrier offset from subcarrier 0 of the first common RB to subcarrier 0 of the SSB.

Embodiment 57: The method of any of embodiments 53 to 56 wherein whether the offset is defined as a number of RBs from the first common RB overlapping with SSB to the lowest RB of the CORESET #0 or defined as a number of RBs from the lowest RB of the CORESET #0 to the first common RB overlapping with the SSB and the indicated offset for CORESET #0 is configurable or indicated (e.g., by the network node 900, e.g., in MIB).

Embodiment 58: The method of embodiment 44 wherein the offset is defined as number of RBs from the lowest RB of the CORESET #0 to a common RB overlapping with a new reference point of the SSB.

Embodiment 59: The method of embodiment 58 wherein the new reference point is a certain subcarrier index other than a lowest index of the SSB.

Embodiment 60: The method of embodiment 58 or 59 wherein the new reference point is either fixed or configurable (e.g., by the network node 900).

Embodiment 61: The method of embodiment 58 wherein the new reference point is a synchronization raster or a subcarrier number #120 of the corresponding SSB.

Embodiment 62: The method of embodiment 58 wherein the new reference point is a subcarrier number #48 of the corresponding SSB.

Embodiment 63: The method of any of embodiments 44 to 62 wherein a channel bandwidth of a wireless channel in which the CORESET #0 is transmitted is less than 5 MHz.

Embodiment 64: The method of any of embodiments 44 to 62 wherein a channel bandwidth of a wireless channel in which the CORESET #0 is transmitted is greater than or equal to 3 MHz and less than 5 MHz.

Embodiment 65: The method of embodiment 42 or 43 further comprising one or more of the following:
transmitting (1404), for reception by one or more User Equipments, UEs, (1402), information that configures one or more parameters related to CORESET #0, the one or more parameters comprising a frequency domain resource allocation for CORESET #0;
determining (1406) that the frequency domain resource allocation for CORESET #0 is greater than a respective channel bandwidth;
responsive to determining (1406) that the frequency domain resource allocation for CORESET #0 is greater than the respective channel bandwidth, performing (1410) PDCCH candidate mapping for CORESET #0 with respect to a new reference frequency domain resource of CORESET #0;
transmitting (1414) a PDCCH in one of one or more PDCCH candidates within CORESET #0 in accordance with the PDCCH candidate mapping for CORESET #0 with respect to the new reference frequency domain resource of CORESET #0.

Embodiment 66: The method of embodiment 65 wherein the new reference frequency domain resource of CORESET #0 is a reference frequency domain resource of CORESET #0 that is different than a reference frequency domain resource of CORESET #0 used for PDCCH candidate mapping if the frequency domain resource allocation for CORESET #0 is not greater than the respective channel bandwidth.

Embodiment 67: The method of embodiment 65 wherein the new reference frequency domain resource of CORESET #0 is fully contained within the respective channel bandwidth.

Embodiment 68: The method of embodiment 65 or 67 wherein the new reference frequency domain resource of CORESET #0 consists of all contiguous PRBs that are confined within the respective channel bandwidth.

Embodiment 69: The method of embodiment 65 wherein a size of the new reference frequency domain resource is smaller than that of the respective channel bandwidth, and the new reference frequency domain resource is positioned within the respective channel bandwidth such that its lowest PRB index is aligned with a lowest PRB index of the respective channel bandwidth.

Embodiment 70: The method of embodiment 65 wherein a size of the new reference frequency domain resource is smaller than that of the respective channel bandwidth, and the new reference frequency domain resource is positioned within the respective channel bandwidth such that its highest PRB index is aligned with a highest PRB index of the respective channel bandwidth.

Embodiment 71: The method of embodiment 42 or 43 further comprising one or more of the following:
transmitting (1504), to a User Equipment, UE, (1502), downlink control information, DCI, that schedules a PDSCH, wherein the DCI comprises a frequency domain resource assignment applied with respect to a size of a new reference frequency domain resource of CORESET #0; and
transmitting (1506) the scheduled PDSCH in accordance with the DCI.

Embodiment 72: The method of embodiment 71 wherein the new reference frequency domain resource of CORESET #0 is a reference frequency domain resource of CORESET #0 that is different than a reference frequency domain resource of CORESET #0 used for PDCCH candidate mapping if the frequency domain resource allocation for CORESET #0 is not greater than the respective channel bandwidth.

Embodiment 73: The method of embodiment 71 wherein the new reference frequency domain resource of CORESET #0 is fully contained within the respective channel bandwidth.

Embodiment 74: The method of embodiment 71 or 73 wherein the new reference frequency domain resource of CORESET #0 consists of all contiguous PRBs that are confined within the respective channel bandwidth.

Embodiment 75: The method of embodiment 71 wherein a size of the new reference frequency domain resource is smaller than that of the respective channel bandwidth, and the new reference frequency domain resource is positioned within the respective channel bandwidth such that its lowest PRB index is aligned with a lowest PRB index of the respective channel bandwidth.

Embodiment 76: The method of embodiment 71 wherein a size of the new reference frequency domain resource is smaller than that of the respective channel bandwidth, and the new reference frequency domain resource is positioned within the respective channel bandwidth such that its highest PRB index is aligned with a highest PRB index of the respective channel bandwidth.

Embodiment 77: The method of embodiment 42 or 43 further comprising transmitting (1704), to a User Equipment, UE, (1702), information that configures an initial downlink BWP in accordance with one or more relaxed restrictions on the initial downlink BWP relative to CORESET #0.

Embodiment 78: The method of embodiment 77 wherein, for NR operation with narrow channel bandwidth of approximately 3 MHz to less than 5 MHz, the relaxed restrictions are such that the initial downlink BWP may not contain the entire CORESET #0.

Embodiment 79: The method of embodiment 77 wherein, for NR operation with narrow channel bandwidth of approximately 3 MHz to less than 5 MHz, the relaxed restrictions are such that the initial downlink BWP still needs to be configured such that it contains the entire CORESET #0.

Embodiment 80: The method of any of the previous embodiments, further comprising: obtaining user data; and forwarding the user data to a host or a user equipment.

### GROUP C EMBODIMENTS

Embodiment 81: A user equipment comprising: processing circuitry configured to perform any of the steps of any of the Group A embodiments; and power supply circuitry configured to supply power to the processing circuitry.

Embodiment 82: A network node comprising: processing circuitry configured to perform any of the steps of any of the Group B embodiments; and power supply circuitry configured to supply power to the processing circuitry.

Embodiment 83: A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 84: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.

Embodiment 85: The host of the previous embodiment, wherein the cellular network further includes a network node configured to communicate with the UE to transmit the user data to the UE from the host.

Embodiment 86: The host of the previous 2 embodiments, wherein: the processing circuitry of the host is configured to execute a host application, thereby providing the user data; and the host application is configured to interact with a client application executing on the UE, the client application being associated with the host application.

Embodiment 87: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Embodiment 88: The method of the previous embodiment, further comprising: at the host, executing a host application associated with a client application executing on the UE to receive the user data from the UE.

Embodiment 89: The method of the previous embodiment, further comprising: at the host, transmitting input data to the client application executing on the UE, the input data being provided by executing the host application, wherein the user data is provided by the client application in response to the input data from the host application.

Embodiment 90: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Embodiment 91: The host of the previous embodiment, wherein the cellular network further includes a network node configured to communicate with the UE to transmit the user data from the UE to the host.

Embodiment 92: The host of the previous 2 embodiments, wherein: the processing circuitry of the host is configured to execute a host application, thereby providing the user data;

and the host application is configured to interact with a client application executing on the UE, the client application being associated with the host application.

Embodiment 93: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Embodiment 94: The method of the previous embodiment, further comprising: at the host, executing a host application associated with a client application executing on the UE to receive the user data from the UE.

Embodiment 95: The method of the previous embodiment, further comprising: at the host, transmitting input data to the client application executing on the UE, the input data being provided by executing the host application, wherein the user data is provided by the client application in response to the input data from the host application.

Embodiment 96: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 97: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 98: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

Embodiment 99: The method of the previous embodiment, further comprising, at the network node, transmitting the user data provided by the host for the UE.

Embodiment 100: The method of any of the previous 2 embodiments, wherein the user data is provided at the host by executing a host application that interacts with a client application executing on the UE, the client application being associated with the host application.

Embodiment 101: A communication system configured to provide an over-the-top service, the communication system comprising a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 102: The communication system of the previous embodiment, further comprising: the network node; and/or the user equipment.

Embodiment 103: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 104: The host of the previous 2 embodiments, wherein: the processing circuitry of the host is configured to execute a host application, thereby providing the user data; and the host application is configured to interact with a client application executing on the UE, the client application being associated with the host application.

Embodiment 105: The host of the any of the previous 2 embodiments, wherein the initiating receipt of the user data comprises requesting the user data.

Embodiment 106: A method implemented by a host configured to operate in a communication system that further includes a network node and a user equipment (UE), the method comprising, at the host, initiating receipt of user data from the UE, the user data originating from a transmission which the network node has received from the UE, wherein the network node performs any of the steps of any of the Group B embodiments to receive the user data from the UE for the host.

Embodiment 107: The method of the previous embodiment, further comprising at the network node, transmitting the received user data to the host.

Those skilled in the art will recognize improvements and modifications to the embodiments of the present disclosure. All such improvements and modifications are considered within the scope of the concepts disclosed herein.

1. A method performed by a User Equipment (UE), the method comprising:
operating in a wireless spectrum allocation that is smaller than an amount of frequency domain resources needed for receiving a Synchronization Signal (SS)/Physical Broadcast Channel (PBCH) block (SSB) and Control Resource Set (CORESET) #0;
receiving, from a network node, the SSB and the CORESET #0 after puncturing at the network node, wherein puncturing of the SSB is determined by a number of resource blocks (RBs) comprised in the wireless spectrum allocation within a respective frequency band and puncturing of a Physical Downlink Control Channel (PDCCH) mapped to the CORESET #0 is determined by the puncturing of the SSB and one or more offset parameters; and
decoding a message based on the PBCH or the PDCCH mapped to the CORESET #0.

2. The method of claim 1, wherein the wireless spectrum allocation is a New Radio (NR) spectrum allocation.

3. The method of claim 1, wherein the one or more offset parameters comprises a SSB subcarrier offset, an offset in a configuration of the CORESET #0, or both the SSB subcarrier offset and the offset in the configuration of the CORESET #0.

4. The method of claim 1, wherein a Primary Synchronization Signal (PSS) and Secondary Synchronization Signal (SSS) comprised in the SSB are unpunctured.

5. The method of claim 4, wherein the PBCH is punctured, and the puncturing of the PBCH depends on which of a set of candidate SSBs is transmitted by the network node as the SSB.

6. The method of claim 1, wherein:
puncturing of the SSB is given by:
a number of resource blocks (RBs) comprised in the wireless spectrum allocation, where a location of the RBs within a respective frequency band determines a set of candidate SSBs to consider depending on a location of a respective synchronization raster, wherein among the set of candidate SSBs only one or more of the candidate SSBs that preserve a Primary Synchronization Signal (RSS) and Secondary Synchronization Signal (SSS) unpunctured are selected as an ultimate selection of the SSB(s) transmitted by the network node in the wireless spectrum allocation;
while the PSS and the SSS are fully preserved, the PBCH is partially preserved, wherein how much of the PBCH is preserved outside a region of the SSB that contains the PSS/SSS depends on the ultimate selection of the SSB(s) transmitted by the network node in the wireless spectrum.

7. The method of claim 1, further comprising receiving, from a network node, information that indicates an offset for CORESET #0, wherein the offset is defined as a number of resource blocks (RBs) from a lowest RB of the CORESET #0 to a first common RB overlapping with the SSB, and the indicated offset for CORESET #0 is one of a predefined set of offsets that comprises one or more negative values.

8. The method of claim 7, wherein the first common RB overlapping with the SSB is a common RB overlapping with SSB having a smallest RB index.

9. The method of claim 8, wherein the first common RB overlapping with the SSB is not necessarily the same as a first RB of the SSB.

10. The method of claim 7, wherein a location of the first common RB overlapping with the SSB is defined by a higher-layer parameter which is the subcarrier offset from subcarrier 0 of the first common RB to subcarrier 0 of the SSB.

11. The method of claim 7, wherein the predefined set of offsets further comprises one or more positive values.

12. The method of claim 7, wherein the predefined set of offsets is defined in a defined table for operation with a channel bandwidth of less than 5 MHz.

13. The method of claim 7, wherein the predefined set of offsets is defined in a defined table that comprises one or more positive offset values and the one or more negative offset values.

14. The method of claim 7, wherein the predefined set of offsets is defined in a defined table in which one or more previously unused entries in the defined table are used to define the one or more negative offset values.

15. The method of claim 1, further comprising receiving, from a network node, information that indicates an offset for CORESET #0, wherein the offset is defined as a number of RBs from the first common RB overlapping with the SSB to the lowest RB of the CORESET #0, and the indicated offset for the CORESET #0 is one of a predefined set of offsets comprising only one or more positive offset values.

16. The method of claim 15, wherein the first common RB overlapping with the SSB is a common RB overlapping with SSB having a smallest RB index.

17. The method of claim 16, wherein the first common RB overlapping with the SSB is not necessarily the same as a first RB of the SSB.

18. The method of claim 15, wherein a location of the first common RB overlapping with the SSB is defined by a higher-layer parameter which is the subcarrier offset from subcarrier 0 of the first common RB to subcarrier 0 of the SSB.

19. The method of claim 15, wherein whether the offset is defined as a number of RBs from the first common RB overlapping with SSB to the lowest RB of the CORESET #0 or defined as a number of RBs from the lowest RB of the CORESET #0 to the first common RB overlapping with the SSB and the indicated offset for CORESET #0 is configurable or indicated by the network node.

20. The method of claim 1, further comprising receiving, from a network node, information that indicates an offset for CORESET #0, wherein the offset is defined as number of RBs from the lowest RB of the CORESET #0 to a common RB overlapping with a new reference point of the SSB.

21. The method of claim 20, wherein the new reference point is a certain subcarrier index other than a lowest index of the SSB.

22. The method of claim 20, wherein the new reference point is either fixed or configurable by the network node.

23. The method of claim 20, wherein the new reference point is a synchronization raster or a subcarrier number #120 of the SSB.

24. The method of claim 20, wherein the new reference point is a subcarrier number #48 of the SSB.

25. The method of claim 7, further comprising performing one or more actions using the CORESET #0 in accordance with the indicated offset.

26. The method of claim 25, wherein performing the one or more actions comprises the decoding the message based on the PBCH or the PDCCH mapped to the CORESET #0.

27. The method of claim 1, wherein a channel bandwidth of the wireless spectrum allocation in which the CORESET #0 is transmitted is less than or equal to 5 MHz.

28. The method of claim 1, wherein a channel bandwidth of the wireless spectrum allocation in which the CORESET #0 is transmitted is in a range of and including 3 MHz to 5 MHz.

29-30. (canceled)

31. A User Equipment (UE) comprising:
a communication interface comprising a transmitter and a receiver; and
processing circuitry associated with the communication interface, the processing circuitry configured to cause the UE to:
operate in a wireless spectrum allocation that is smaller than an amount of frequency domain resources needed for receiving a Synchronization Signal (SS)/Physical Broadcast Channel (PBCH) block (SSB) and Control Resource Set (CORESET) #0;
receive, from a network node, an SSB and CORESET #0 after being punctured at the network node, wherein puncturing of the SSB is determined by a number of resource blocks (RBs) comprised in the wireless spectrum allocation within a respective frequency band and puncturing of a Physical Downlink Control Channel (PDCCH) mapped to the CORESET #0 is determined by the puncturing of the SSB and one or more offset parameters; and
decode a message based on the PBCH or a Physical Downlink Control Channel (PDCCH) mapped to the CORESET #0.

32-58. (canceled)

59. A method performed by a network node, the method comprising:
serving a User Equipment (UE) in a wireless spectrum allocation that is smaller than frequency domain resources needed for reception by the UE of a Synchronization Signal Block (SS)/Physical Broadcast Channel (PBCH) block (SSB) and Control Resource Set (CORESET) #0; and
transmitting an SSB and a Physical Downlink Control Channel (PDCCH) mapped to the CORESET #0 after puncturing, wherein puncturing of the SSB is determined by a number of resource blocks (RBs) comprised in the wireless spectrum allocation within a respective frequency band and puncturing of a Physical Downlink Control Channel (PDCCH) mapped to the CORESET #0 is determined by the puncturing of the SSB and one or more offset parameters.

60. The method of claim 59, wherein the wireless spectrum allocation is a New Radio (NR) spectrum allocation.

61. The method of claim 59, wherein the one or more offset parameters comprises a SSB subcarrier offset, an offset in a configuration of the CORESET #0, or both the SSB subcarrier offset and the offset in the configuration of the CORESET #0.

62. The method of claim 59, wherein a Primary Synchronization Signal (PSS) and Secondary Synchronization Signal (SSS) comprised in the SSB are unpunctured.

63. The method of claim 62, wherein the PBCH is punctured, and the puncturing of the PBCH depends on which of a set of candidate SSBs is transmitted by the network node as the SSB.

64. The method of claim 59, wherein:
puncturing of the SSB is given by:
a number of resource blocks (RBs) comprised in the wireless spectrum allocation, where a location of the RBs within a respective frequency band determines a set of candidate SSBs to consider depending on a location of a respective synchronization raster, wherein among the set of candidate SSBs only one or more of the candidate SSBs that preserve a Primary Synchronization Signal (PSS) and Secondary Synchronization Signal (SSS) unpunctured are selected as an ultimate selection of the SSB(s) transmitted by the network node in the wireless spectrum allocation;
while the PSS and the SSS are fully preserved, the PBCH is partially preserved, wherein how much of the PBCH is preserved outside a region of the SSB that contains the PSS/SSS depends on the ultimate selection of the SSB(s) transmitted by the network node in the wireless spectrum.

65. The method of claim 59, wherein a channel bandwidth of the wireless spectrum allocation is less than or equal to 5 MHz.

66. The method of claim 59, wherein a channel bandwidth of the wireless spectrum allocation is in a range of and including 3 MHz to 5 MHz.

67-68. (canceled)

69. A network node comprising processing circuitry configured to cause the network node to:
serve a User Equipment (UE) in a wireless spectrum allocation that is smaller than frequency domain resources needed for reception by the UE of a Synchronization Signal Block (SS)/Physical Broadcast Channel (PBCH) block (SSB) and Control Resource Set (CORESET) #0; and
transmit an SSB and a Physical Downlink Control Channel (PDCCH) mapped to the CORESET #0 after puncturing, wherein puncturing of the SSB is determined by a number of resource blocks (RBs) comprised in the wireless spectrum allocation within a respective frequency band and puncturing of a Physical Downlink Control Channel (PDCCH) mapped to the CORESET #0 is determined by the puncturing of the SSB and one or more offset parameters.

70-79. (canceled)
